(19) United States
(12) Patent Application Publication
(10) Pub. No.: US 2021/0037814 A1
(43) Pub. Date: Feb. 11, 2021

(54) DEVICE AND METHOD FOR FREEZE DRYING BIOLOGICAL SAMPLES

(71) Applicant: FERTILESAFE LTD., Ness Ziona (IL)

(72) Inventor: Amir ARAV, Ness Ziona (IL)

(21) Appl. No.: 16/963,974

(22) PCT Filed: Jan. 11, 2019
(86) PCT No.: PCT/IB2019/000037

§ 371 Date: Jul. 22, 2020

Related U.S. Application Data
(60) Provisional application No. 62/619,934, filed on Jan. 22, 2018.
(60) Provisional application No. 62/634,868, filed on Feb. 25, 2018.

(51) Int. Cl. A01N 1/02

(52) U.S. Cl. CPC A01N 1/0284; A01N 1/0252; A01N 1/0294

(57) ABSTRACT

A method for freeze-drying a biological sample of mammalian cells or tissue including placing a biological sample on or in a structure to increase a temperature of the biological sample and with the biological sample in a closed chamber applying a vacuum to the chamber to lower a pressure within the chamber, cooling the chamber to lower a temperature within the chamber and applying heat to the biological sample within the chamber. The biological sample can include one or more of stem cells, hematopoietic stem cells, mesenchymal stem cells, embryonic stem cells, induced pluripotent stem cells, sperm, oocytes, embryos, ovarian tissue, uterine tissue or testicular tissue.

### BACKGROUND OF THE INVENTION

This application claims priority from provisional application Ser. No. 62/619,934, filed Jan. 22, 2018, and provisional application Ser. No. 62/634,868, filed Feb. 25, 2018. The entire contents of each of these applications are incorporated herein by reference

### Field of the Invention

This application relates to methods for freeze-drying biological samples such as sperm, oocytes, embryos, reproductive tissues and stem cells and devices for performing such freeze drying.

### Background of Related Art

Cryopreservation works fairly well for gametes of both sexes as well as embryos of many domestic and wildlife species. Various species have their unique aspects, sensitivities, and limitations but germplasm can be cryopreserved, stored and eventually used in assisted reproductive programs. This effective cryopreservation method, however, comes with a heavy price tag. Maintaining cryopreserved samples in storage under liquid nitrogen (LN) has high maintenance costs and requires dedicated specialized facilities and trained staff. Additionally, shipping is cumbersome and very expensive and there is a need for guaranteed and continuous LN supply. An additional disadvantage is there is a risk of pathogen transmission either due to “dirty” LN or between samples due to a contaminated sample. Another disadvantage in storing biological samples in liquid nitrogen is the risk of malfunction of the tank and the irreversible loss of samples. Besides these intrinsic problems, the industrial production and distribution of LN and the energy demands of the dedicated storage facilities have a serious environmental impact, leaving a massive carbon footprint.

It would be advantageous to provide an alternative to liquid nitrogen cryopreservation. Such alternative would overcome the foregoing limitations and disadvantages by reducing costs, simplifying the process, reducing risk of contamination and minimizing impact on the environment.

### SUMMARY OF THE INVENTION

The present invention overcomes the drawbacks and deficiencies of liquid nitrogen cryopreservation for biological samples including sperm cells, oocytes, embryos and reproductive tissues by providing a desiccation process of freeze-drying of the sperm cells, oocytes, embryos and reproductive tissues such as ovarian, uterine and testicular. The biological samples are immersed in a special freeze-drying solution/solutions and are then frozen and dried, using the apparatus disclosed herein. The results upon subsequent rehydration are such that can be used for assisted reproduction technologies such as in-vitro fertilization (IVF), Intracytoplasmic sperm injection (ICSI), genetic screening including preimplantation genetic screening (PGS), genetic diagnostic tests including preimplantation genetic diagnosis (PGD), and more.

The liquid nitrogen cryopreservation alternative of the present invention can also be utilized for stem cell preservation.

The present invention provides both a process for freeze drying preservation and a device for performing such process, both of which are described in detail below. The process involves a low temperature dehydration process which involves rapidly freezing the biological sample, lowering the pressure, and removing ice by sublimation. This is performed in a small volume which advantageously speeds up the process.

In accordance with one aspect of the present invention, a method is provided for freeze-drying a biological sample such as mammalian cells or tissue, the method comprising placing one or more of a droplet, a small volume or a slice of the biological sample in a device having a chamber and with the biological sample in the closed chamber applying a vacuum to the chamber to lower a pressure within the chamber, cooling the chamber to lower a temperature within the chamber and applying heat to the biological sample within the chamber.

In some embodiments, the biological sample, to increase the temperature of the sample, is placed on a pre-cooled metal surface when the pre-cooled surface is within the chamber; in other embodiments, the biological sample is placed on the pre-cooled metal surface or in a vial outside the chamber and the pre-cooled surface is subsequently placed within the chamber.

In some embodiments of the methods herein, the biological sample includes one or more of sperm, oocytes, embryos, ovarian tissue, uterine tissue or testicular tissue stem cells, hematopoietic stem cells, mesenchymal stem cells, embryonic stem cells, or induced pluripotent stem cells either from human source or animal source.

In some embodiments, the biological sample is diluted in a LYO solution. In some embodiments, the LYO solution is composed of a) DMSO and a carbohydrate or b) DMSO and a protein. In some embodiments, the LYO solution is a combination of one or more of sucrose, sorbitol, Glucose dextran and trehalose and cryoprotectants such as DMSO, EG, PG, glycerol and macromolecules such as HSA, FCS and antioxidants such as Astaxanthin, EGCG, Ascorbic acid. In some embodiments, the LYO solution can be with a buffer or medium solution comprising one or more of TCM-199, Tris, PBS or Hepes Talp, RPMI-1640, Dulbecco's Modified Eagle Medium. In some embodiments, the LYO solution is composed of Tris medium, egg yolk, Trehalose and Sorbitol. In some embodiments, the LYO solution contains 10% DMSO and 10% HSA.

In some embodiments the method includes exposing the sample in progressively lower concentrations of the LYO solution until reaching a final concentration.

In some embodiments, the step of cooling the chamber comprises the step of inserting at least a part of the chamber in a container of liquid nitrogen or other cryogenic fluid. A condenser in the chamber and/or the biological sample can in some embodiments remain above a level of the liquid nitrogen when the chamber is placed in the container of liquid nitrogen. The temperature in the chamber in some embodiments is regulated by a level of the chamber/condenser with respect to the level of the liquid nitrogen.

In some embodiments, the biological sample is cooled at a slow rate to seeding temperatures between −3 C and −10 C and further to subzero temperature between −7 C and −50 C.

In some embodiments, the chamber is composed of a plastic material of polycarbonate, polypropylene or Teflon.

In some embodiments, the Lyo solution is a ratio between percentage of lyoprotected additive and cell concentration. In some embodiments, the lyloprotective additive is DMSO or Trehalose.

In accordance with another aspect of the present invention, a method for freeze-drying and rehydrating biological samples is provided comprising a) inserting a carrier containing at least one biological sample into a first LYO solution; b) removing the carrier from the first LYO solution and placing the carrier in a second LYO solution, the second LYO solution being different than the first LYO solution; c) placing the carrier in a chamber of a device, the chamber having a container for holding the at least one biological sample and a condenser for lowering the temperature within the chamber; d) freeze drying the at least one biological sample by applying a vacuum to the chamber to lower the pressure within the chamber, lowering the temperature within the chamber, and heating the at least one biological sample; and e) after step (c) removing the carrier from the device and inserting the carrier into a third solution and subsequently removing the carrier from the third solution and inserting the carrier into a fourth solution to rehydrate the at least one biological sample.

In some embodiments, the samples are rehydrated in a rehydration solution at temperature of 22° C., 30° C. or 37° C. which contain sugars comprising one or more of Sorbitol, Sucrose and/or Trehalose in a medium for the rehydration of stem cells.

In some embodiments, the dried cells are exposed to irradiation such as UV.

In preferred embodiments, the chamber has a volume of less than or equal to two liters and in more preferred embodiments, has a volume of less than or equal to 1.5 liters, and in more preferred embodiments, a volume of less than or equal to 1 liter.

In preferred embodiments, a distance from the biological sample to the condenser is equal to or less than 10 cm, and in more preferred embodiments, a distance from the biological sample to the condenser is equal to or less than 2 cm.

In accordance with another aspect, a method is provided for rehydrating samples in rehydration solution at a temperature of 37 C which contain sugars such as Sorbitol, Sucrose and Trehalose in egg yolk solution and TRIS medium for the rehydration of sperm and 1M Trehalose or Sucrose for rehydration of oocytes, embryos or ovarian tissue.

In accordance with another aspect, a method for freeze-drying a biological sample is provided comprising placing a biological sample in a device having a closed chamber, the closed chamber defined as an area within the device wherein pressure is to be reduced and the chamber has a volume of less than or equal to 1.5 liters. The method further includes applying a vacuum to the chamber to lower a pressure within the chamber, cooling the chamber to lower a temperature within the chamber and applying heat to the biological sample the chamber.

In some embodiments, the volume is less than or equal to 1 liter.

In accordance with another aspect of the present invention, a method for freeze-drying a biological sample is provided, the method comprising placing a biological sample in a device having a closed chamber, the closed chamber defined as an area within the device wherein pressure is to be reduced, and the chamber having a volume defined therein. The device has a condenser within the chamber wherein the biological sample is placed within the chamber such that a distance between the condenser and the sample is equal to or less than 10 cm. the method includes applying a vacuum to the chamber to lower a pressure within the chamber, cooling the chamber to lower a temperature within the chamber and applying heat to the biological sample in the chamber.

In some embodiments, a distance from the biological sample to the condenser is equal to or less than 2 cm.

In accordance with another aspect of the present invention, a method for freeze-drying a biological sample is provided comprising a) placing a biological sample in a device having a closed chamber, the closed chamber defined as an area within the device wherein pressure is to be reduced; b) placing the device in a container of cryogenic fluid to cool the chamber; c) applying a vacuum to the chamber to lower a pressure within the chamber; and d) applying heat to the biological sample the chamber.

In the foregoing, the chamber is open and then closed/sealed after placement of the sample.

In some embodiments, the step of placing the device in the container of cryogenic fluid to cool the chamber positions a condenser within the chamber so the condenser is spaced from the cryogenic fluid so the condenser remains outside the fluid. The cryogenic fluid can be liquid nitrogen.

Preferably, a distance from the biological sample to the condenser is equal to or less than 10 cm, and more preferably the distance from the biological sample to the condenser is equal to or less than 2 cm.

Preferably, the chamber has a volume of less than or equal to two liters and in more preferred embodiments, has a volume of less than or equal to 1.5 liters, and in more preferred embodiments, a volume of less than or equal to 1 liter.

In accordance with another aspect of the present invention, a device for freeze drying a biological sample is provided comprising a) a first container having a first internal space, the first container configured for storing the biological sample exposed to an internal environment of the first internal space, wherein the first container is configured to facilitate sublimation of ice crystals from the biological sample; and b) a condenser configured to be subjected to a cool environment to facilitate phase transition of water vapors into a solid, the condenser having a second internal space couplable to and in communication with the first internal space, the first and second internal space forming a closed chamber such that the biological sample and the condenser are in the same chamber, the chamber couplable to a vacuum pump; c) wherein the first container and the condenser are configured to prevent exchange of particles between the closed internal space and an external environment.

In some embodiments the device further comprises a cooling element for supplying energy to the condenser to cool the condenser and the first and second internal spaces; in other embodiments, the device is positionable in a container of cryogenic fluid to cool the condenser. In some embodiments, the cryogenic fluid is in the container at a first level and the condenser is positionable in the container spaced from the cryogenic fluid so the condenser remains outside the fluid.

The cryogenic fluid, e.g., liquid nitrogen, container can include in some embodiments an elevation element supporting the condenser in a position above the cryogenic fluid level, and he elevation element can be adjustable to adjust a distance of the condenser above the cryogenic fluid level.

In accordance with another aspect of the present invention, a device for freeze drying a biological sample is provided comprising a) a holder for holding the biological sample, the holder positioned in a closed chamber; b) a condenser positioned within the closed chamber for cooling the chamber; c) an inlet communicating with the chamber and in communication with a vacuum source; d) wherein the closed chamber defines an area where pressure is reduced by the vacuum source, and the closed chamber has a volume of less than 2 liters. In some embodiments, an internal volume of the closed chamber is equal to or below 1.5 liters and some embodiments equal to or below 1 liter.

In accordance with another aspect of the present invention, a method of freeze drying a plurality of biological samples contained in separate devices is provided comprising a) placing a first device containing a first biological sample in a first container, the first container containing a cryogenic fluid therein; b) placing a second device containing a second biological sample in the first container containing the cryogenic fluid therein; and c) activating a vacuum pump to lower the pressure in a first chamber of the first device without applying a vacuum to a second chamber in the second device.

In some embodiments, the method includes the step of closing off the vacuum to the first chamber and applying a vacuum from the same vacuum pump to the second chamber while the second device remains in the cryogenic fluid. The first and second devices can have a valve to selectively open and close off the vacuum.

The biological sample can include one or more of stem cells, hematopoietic stem cells, mesenchymal stem cells, embryonic stem cells, induced pluripotent stem cells either from human source or animal source, sperm, oocytes, embryos, ovarian tissue, uterine tissue or testicular tissue.

### BRIEF DESCRIPTION OF THE DRAWINGS

So that those having ordinary skill in the art to which the subject invention appertains will more readily understand how to make and use the surgical apparatus disclosed herein, preferred embodiments thereof will be described in detail hereinbelow with reference to the drawings, wherein:

FIG. 1 is a schematic view of a device for freeze drying one or more biological samples in accordance with one embodiment of the present invention;

FIG. 2 is a schematic view of a device for freeze drying one or more biological samples in accordance with another embodiment of the present invention;

FIG. 3 is side perspective view of a device for freeze drying one or more biological samples in accordance with another embodiment of the present invention utilizing active cooling;

FIG. 4 is a side perspective view of a device for freeze drying one or more biological samples in accordance with another embodiment of the present invention utilizing passive cooling;

FIG. 5 is a side view of an alternate embodiment of a device for freeze drying one or more biological sample utilizing passive cooling;

FIG. 6 is a side view of an elevation element to change the level of the condenser inside the cryogenic fluid container;

FIG. 7 is a cutaway view of a container and an upper part of a condenser in a device for freeze drying one or more biological samples in accordance with another embodiment of the present invention;

FIG. 8 is a cutaway view of an alternate embodiment of a container of the present invention having two trays for storing biological samples;

FIGS. 9A and 9B are perspective views of another embodiment of the container of the present invention for storing biological samples;

FIG. 10A is a side view of another embodiment of the container of the present invention for storing biological samples;

FIG. 10B is a side view of another embodiment of the device for freeze drying biological samples;

FIG. 10C is a cutaway view of another embodiment of the device shown in a liquid nitrogen container;

FIG. 10D illustrates the internal components of the device of FIG. 10C;

FIG. 11A is a diagram of the system for freeze drying the sample;

FIG. 11B is a block diagram of the device for freeze drying the sample;

FIG. 12 illustrates a system for freeze drying a sample of sperm in accordance with one embodiment of the method of the present invention;

FIG. 13A illustrates a system for freeze drying a biological sample in accordance with another embodiment of the present invention

FIG. 13B is a flow chart depicting the overall steps for freeze drying the biological sample in accordance with the method of FIG. 13A;

FIG. 14 illustrates the method of rehydrating a biological sample in accordance with one method of the present invention

FIG. 15 is a flow chart showing the steps of the freeze drying process and rehydrating depicted in accordance with the method of FIGS. 13A and 14;

FIG. 16 shows Hoilowsperm staining of irradiated frozen sperm (left) and irradiated freeze dried sperm (right) in accordance with the test described herein;

FIG. 17 illustrates the results after rehydration and staining with Haematoxylin Eosin for fresh control and freeze dried tissue in accordance with the test described herein;

FIG. 18 shows microscopy images of samples frozen (a,b) and freeze-dried (c,d); and

FIG. 19 shows scanning electron microscopic images frozen in LYO solution.

### DETAILED DESCRIPTION OF PREFERRED EMBODIMENTS

The present invention provides devices for freeze drying biological samples and methods for such freeze drying. The biological samples can be mammalian cells or tissue. The biological samples can include for example oocytes, embryos, sperm, reproductive tissue, ovarian tissue, uterine tissue, testicular tissue, stem cells, hematopoietic stem cells, mesenchymal stem cells, embryonic stem cells, induced pluripotent stem cells, etc. either from human source or animal source. The present invention also provides rehydrating the samples for use after the freeze drying process.

The devices of the present invention advantageously effect sublimation within a closed chamber without damaging the biological samples contained therein. In processes where sublimation is started too early, it will have a negative impact on the samples. The devices of the present invention utilize a small volume and reach desired vacuum pressure in a short period of time, thereby sublimation can be achieved without damaging the sample. Moreover, the devices of the present invention have the advantage of maintaining sterility. Due to its size, the device can be placed in a sterilizer. Additionally, due to its size and simplicity which reduces the cost of the device, the device can in certain embodiments be formed of a disposable material for disposal after use.

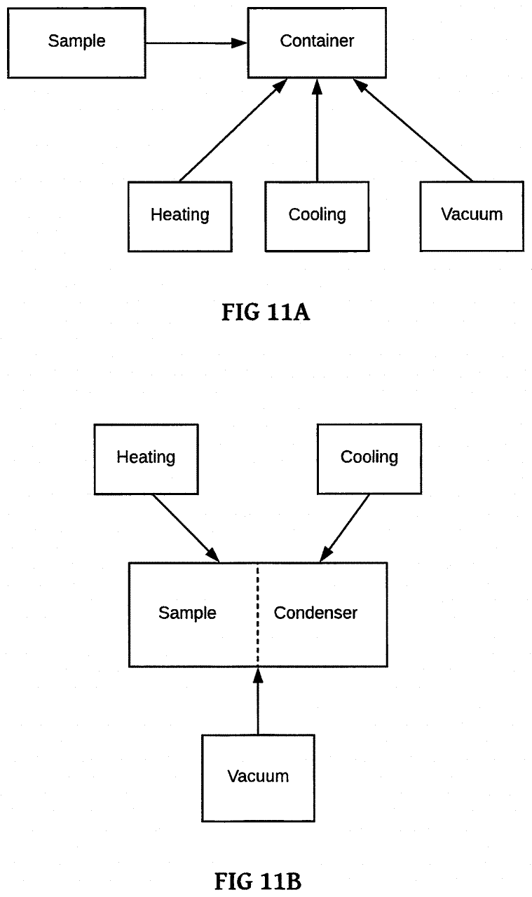

The freeze drying devices of the present invention create a closed chamber with a condenser for decreasing the temperature within the chamber, a vacuum for lowering the pressure within the closed chamber and a heater (spaced from the condenser) to heat the biological sample within the container for the sublimation process, all described in detail below. This is also shown in the diagrams of FIGS. 11A and 11B, discussed in detail below.

The methods of the present invention use the device for freeze drying the sample, to be followed subsequently by rehydrating at the desired time for use. Various methods are described in detail below, with some examples of test results showing the attendant advantageous results of the freeze drying method of the present invention.

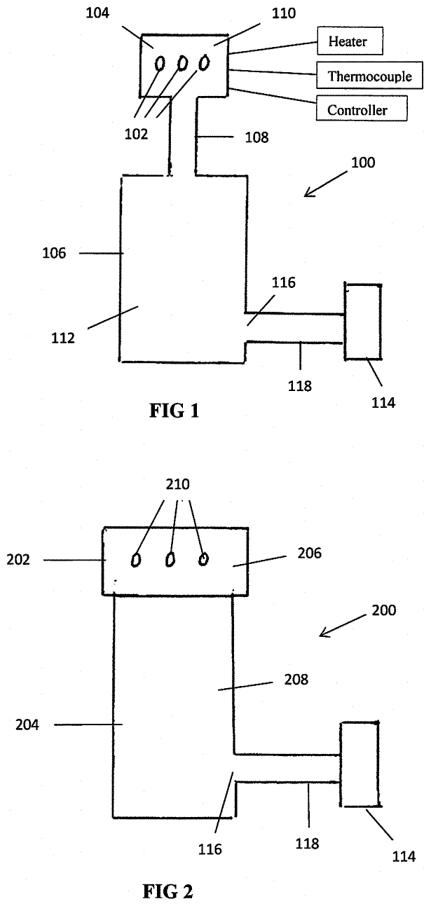

Initially, the devices for freeze drying the biological samples will be discussed in conjunction with FIGS. 1-10D. FIGS. 1-5 illustrate various embodiments for supporting and freeze drying (e.g., lyophilizing) one or more biological samples. In the following description components that are common to more than one figure will be referenced by the same reference numerals, unless specifically noted otherwise. In addition, unless specifically noted otherwise, embodiments described or referenced in the present description can be additional and/or alternative to any other embodiment described or referenced therein.

In these devices, two internal containers are provided: one supporting (storing) the biological sample(s) and one containing the condenser. The internal spaces of the two containers are in communication and together form a closed internal space, also referred to as a closed chamber, which is sealed from the external environment. A vacuum is applied to the closed internal space to lower the pressure within the space. The device is cooled either by passive cooling or by active cooling, both of which are described below, to lower the temperature. The samples are held in vials or other holders within the container and are heated by various methods. With these features, sublimation is achieved without damaging the samples.

### Devices for Freeze Drying Samples

Turning first to the embodiment of FIG. 1, the device for freeze drying (lyophilizing) one or more biological samples 102 is illustrated schematically and designated by reference numeral 100. The device comprises a sample supporting or sample storing (holding) container 104 having an internal space 110. For ease of explanation, the sample holding container 104 will also be referred to herein as the “first container” having a “first internal space.” Condenser 106 is positioned below container 104 in this embodiment and has an internal space 112. For ease of explanation, the space 112 inside condenser 106 will also be referred to as second internal space 112. The first internal space 110 and the second internal space 112 are in fluid communication as they are coupled via first coupling element 108 to constitute together a “closed internal space.” Thus, the closed internal space is defined by the internal spaces of the first container 104, condenser 106 and coupling element 108. As shown, coupling element 108 forms a narrower passageway between container 104 and condenser 106, however, other shapes and dimensions could alternatively be provided.

Condenser 106 is coupled to a vacuum pump 114, a device that is configured to remove gas molecules from a sealed volume (or, in other words, a sealed space) in order to turn this sealed volume into partial vacuum. Coupling of the pump 114 to condenser 106 is made via opening 116 in condenser 116 to which pump 114 is coupled via a second coupling element or connecting tube 118. Various types of pumps can be utilized. In some embodiments, for example, the vacuum pump reduces vacuum below 1 Torr. The coupling 118 provides a passageway from the pump 114 to the condenser 106. In the embodiment of FIG. 1, the vacuum pump 114 is directly coupled to the condenser 106, i.e., vacuum pump 114 is coupled via opening 116 in the condenser's wall and affects the pressure in second internal space 112 of condenser 106. Because second internal space 112 forms part of the closed internal space, the vacuum pump 114 influences the pressure in the closed internal space, including the first internal space 110 which is in communication with the second internal space 112. Accordingly, vacuum pump 114 is considered to be indirectly coupled to first container 104. That is, vacuum pump 114 can be considered directly coupled to second internal space 112 and indirectly coupled to first internal space 110.

It should be appreciated that in alternate embodiments, the vacuum pump 114 can be directly coupled to the first container 104 while being indirectly coupled to condenser 106 via a coupling element such as first coupling element 108 which would be in communication with an opening in the first container 104 and with an opening in the condenser. The vacuum pump 114 could also alternatively be mounted to the first coupling element 108 via an opening in the coupling element 108 wherein it would be indirectly coupled to both the first container 104 and the condenser 106. However, in any of these variations, since the first and second internal spaces are in communication, connection of the vacuum pump to any part of the closed internal space achieves the desired objective of transforming the sealed volume i.e., lowering the pressure in the closed internal space.

First container 104 is configured to store one or more biological samples 102, herein referred to, shortly, as “a sample” or “samples”. That is, in the description herein, when the term “sample” is used in the discussion of the first container or other holders/carriers, it should be understood that multiple samples are also contemplated so that for understanding the function and objectives of the devices and methods herein, the term “sample” should be interpreted to mean a single sample or multiple samples.

In FIG. 1 three samples are illustrated by way of example though this is non-limiting and any applicable number of samples can be stored in the first container and freeze-dried by device 100, such as one sample, 2 samples, 4-10 samples, or any other applicable number of samples. That is, first container 104 may be configured to store one sample or multiple samples (i.e., one or more samples), as desired/required. The biological samples can be placed into the device by any applicable method to keep them inside the first container 104 and to protect them from damage triggered or produced by temperature or by negative pressure or even by mechanical damage. The samples can be placed within vials such as glass vial, cryovials or other types of vials that allow heat transfer from the heater to the holder and through the vials to the samples to facilitate sublimation as described herein. The samples can also be placed on a pre-cooled metal surface, the pre-cooled surface being in the device or alternatively outside the device and after depositing the samples on the surface placed in the device. The vials can be pre-cooled before placing within the device.

The samples within the vials can be heated for sublimation by various methods such as by irradiation via an infrared lamp or by other sources of energy, e.g., electric heating, radiofrequency, etc. A thermocouple for measuring temperature and a controller for controlling the temperature are also provided, and shown schematically for example in FIG. 1. The thermocouple, controller and heater are also applicable to the other devices disclosed herein, although schematically shown only in conjunction with FIG. 1.

FIG. 2 is a schematic representation of an alternate embodiment of the device for freeze drying one or more biological samples. Device 200 has sample supporting (holding/storing) container 202, also referred to herein as a first container 202, and a condenser 204 positioned below the first container 202 in the view of FIG. 2. In this embodiment, first container 202 is coupled directly to condenser 204, i.e., it does not have the coupling (connecting) element 108 as in FIG. 1 separating the first container and condenser. As in the device 100 of FIG. 1, the space inside first container 202 constitutes a first internal space 206 and the space inside condenser 204 constitutes a second internal space 208, together forming a closed internal space or chamber. However, unlike device 100 of FIG. 1, in device 200, the first internal space 206 is directly coupled to the second internal space 208 forming the closed internal space. That is, in this embodiment, coupling is done without a coupling element such as the coupling element 108 in FIG. 1.

Device 100 and device 200 both illustrate embodiments for dry-freezing one or more biological samples. Unless as noted herein, when device 100 or device 200 is mentioned (as well as FIG. 1 or 2, or constituents thereof), whatever applies thereto applies also to the other device (or figure or constituent). For example, if a certain explanation is provided with reference to first container 104, this explanation is applicable also to first container 202, reference to condenser 204 is applicable also with reference to condenser 106, reference to first internal space 110 is applicable to first internal space 206, etc.

As with container 104, container 202, and any of the other containers disclosed herein for supporting the biological samples, is configured to support (store) one or more samples, e.g., 1-10 samples.

Similar to condenser 106 of FIG. 1, condenser 204 of FIG. 2 may be directly or indirectly coupled to a vacuum pump 114. In FIG. 2, it is shown directly coupled to pump 114 via a second coupling element 118 providing a passageway from pump 114 to condenser 204 via opening 116.

As with container 104, the biological samples in container 202, and in the other containers disclosed herein, are heated by various methods such as those described herein.

Generally, the device according to the embodiments of the invention disclosed herein enclose a closed internal space, isolated from the external environment where the device is positioned. In this manner, air, or any other gas from the external environment, is prevented from penetrating into the closed internal space. Additionally, gas confined within the device's closed internal space is prevented from leaving the closed internal space and exiting into the external environment, unless it is pumped out by pump 114. Accordingly, further to pumping out gaseous content from the closed internal space, the pressure inside the closed internal space becomes less than the external pressure. For example, if the external pressure is atmospheric pressure, the pressure inside the closed internal space would become lower than atmospheric pressure due to application of the vacuum. Thus, the closed internal space would turn into a partial vacuum. For matter of simplicity, the closed internal space, resulting from pumping out gaseous contents therefrom, is referred to, shortly, as a “vacuum”.

When pressure and temperature are below a triple point of a substance in the substance's phase diagram (defined at which the three phases coexist in thermodynamic equilibrium), sublimation occurs—transitioning directly from the solid phase to the gas phase without passing through the intermediate liquid phase. Biological samples, such as one or more samples 102 (or samples 210) comprise water. Hence, according to embodiments of the invention, if pressure and temperature in the closed internal space are low enough to allow sublimation of water, the samples would dry. Therefore, given the temperature inside the closed internal space, the vacuum pump should be operated until pressure and temperature are below the triple point of water. The vacuum pump is therefore preferably configured to reduce pressure to such a low pressure to allow sublimation. Note that in order for sublimation to occur it has to be below the triple point of water but since it is an endothermic process it requires heat.

Then, when sublimation of water occurs in the sample(s), it would be possible to condense (or even deposit) the water vapors in the condenser, thereafter splitting the first container (such as container 104 or 202) from the condenser (such as condenser 106 or 204) and sealing the first container to prevent entry of humidity from the environment, thereby leaving the dried sample(s) preserved in the first container.

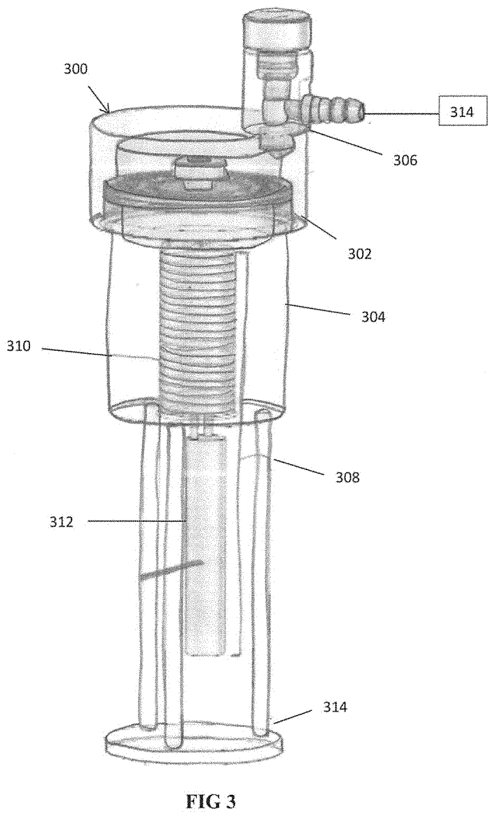

FIG. 3 illustrates an alternate embodiment of the device for freeze drying one or more biological samples. Device 300 includes a sample supporting (holding) container 302 (also referred to herein as the first container), a condenser 304 shown below container 302 and an outlet 306. Device 300 is of the type of device 200 of FIG. 2 as its first container 302 is directly coupled to condenser 304, however, it differs from device 200 in that outlet 306 is in the first container 302 rather than in the condenser. Therefore, the vacuum pump 314 (shown schematically) which can be similar to pump 114 of FIG. 2, is directly connectable (couplable) to first container 302 which holds the sample and indirectly connectable to condenser 304. Container 302 and condenser 304 each have an internal space which together form a closed internal space or closed chamber.

Device 300 includes an internal cooling mechanism 308. The internal cooling mechanism includes a cooling coil 310 and a cooler unit 312. The cooling mechanism 308 can be a mechanism currently on the market, for example, the EK™ Immersion Coolers by Thermo Scientific™. In the embodiment of FIG. 3, cooling coil 310 can be external to the condenser 304 and outside the chamber and cooler unit 312 can be external to the condenser and is shown in this embodiment below the coil 310. Consequently, internal cooling mechanism 308 needs to traverse the wall of device 300. Since upon vacuum pump operation the closed internal space becomes partial vacuum, the wall traversal needs to be sealed and resistant to low pressure conditions as well as to low temperature conditions, or it will fail when the internal cooling mechanism operates. A failed traversal would result with deteriorated low pressure generation, loss of low pressure conditions, and sublimation halt. Moreover, a failed traversal may also damage the sterility of the samples and/or of the cryogenic fluid, though this will be discussed below. Note the external placement of the cooling mechanism results in condensation not on the coil but condensation is just in the wall.

As mentioned above, sample supporting containers 104, 202 and accordingly also sample supporting container 302 and the other sample support containers disclosed herein can be split from the condenser and sealed in order to preserve the dried biological samples in partial vacuum. Upon this splitting and also disconnecting the vacuum pump 314, in order to seal the first container 104, 202, or 302 or other sample supporting containers, the outlet 306 also needs to be sealed. Accordingly, device 300 includes a valve 314 that can be closed prior to pump disconnection, thereby maintaining the low pressure inside container containing the biological sample(s). Various types of valves can be utilized to seal the outlet in the various embodiments.

Valves could also be utilized with the other embodiments herein to maintain the pressure. That is, a valve(s) can also be used with an outlet positioned in other parts of the device, such as an outlet in the condenser (e.g., condensers 106, 204, 304) or in the first coupling element 108.

As explained above, device 300 has a cooling mechanism 308 that traverses the wall of the device. Turning back to device 100 of FIG. 1 and device 200 of FIG. 2, an alternative cooling method that does not require traversal of the device's wall can be used. In this alternative method, the condenser (and in some embodiments also the sample supporting/carrying container) of the device is inserted into a container containing cryogenic fluid. Note that various cryogenic fluids can be used. Thus, although the description below refers mainly to the use of liquid nitrogen, it should be understood that this is non-limiting as alternatively liquid air may be used as well as other cryogenic fluids such as carbon dioxide, nitrogen slush etc.

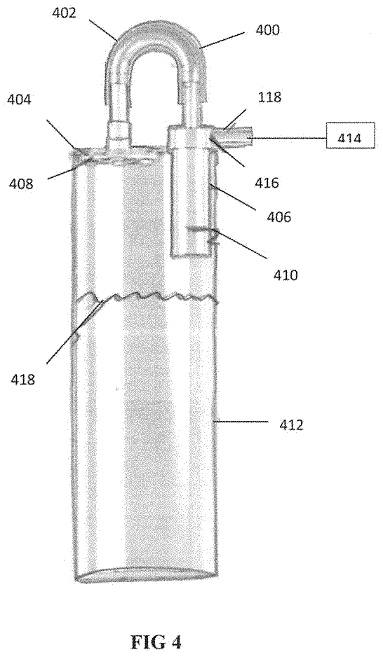

It is noted that the condenser and the first container containing the samples do not need to be submerged in liquid nitrogen, as long as the temperature inside the cryogenic fluid container, and the low pressure inside the closed internal space, are below the triple point of water in the water's phase diagram. FIGS. 4 and 5 illustrate embodiments utilizing cryogenic fluid for cooling without requiring direct contact of the condenser with the fluid.

Note that with the use of liquid nitrogen the sample can be held at a low temperature below its glass transition temperature and condensation is below the glass transition temperature. Also with the device placed within the liquid nitrogen container, the liquid nitrogen remains outside the chamber.

Turning to FIG. 4 the freeze drying device is designated generally by reference numeral, 400. Device 400 is of the type of device similar to device 100 of FIG. 1 as the sample holding container and condenser are directly coupled as device 400 includes a coupling member 402 that couples a first container 404 (which contains the sample) to a condenser 406. Such coupling connects the first internal space 408 inside first container 404 and the second internal space 410 inside condenser 406. Device 400 is shown with first container 404 as well as condenser 406 inserted into a liquid nitrogen container 412 (or container holding other cryogenic fluid), whose level of liquid nitrogen is depicted by 418. As illustrated, neither condenser 406 nor first container 408 are submerged in the liquid nitrogen as they are above fluid line 418. The low temperature inside the liquid nitrogen container 412 is inherent to the liquid nitrogen and therefore cooling is facilitated passively by exposing device 400 to the inherent low temperature. This is unlike active cooling, requiring investment of energy (such as electrical energy) in order to cool the environment, for example, by a refrigerator or by a cooler unit such as unit 312 of FIG. 3.

Outlet 416 in the wall of condenser 410 is used for coupling a vacuum pump 414 (shown schematically) similar to pump 114 wherein outlet 416 is positioned external of the liquid nitrogen container 414. Coupling element 118 connects the pump 414 to the outlet 416. Being external of the liquid nitrogen container 412, the outlet 416 and the pump 414 are not exposed to temperature as low as the temperature inside the liquid nitrogen container 414, which simplifies the sealing of the passage between the condenser's internal space 410 and the pump 414. A valve to close the vacuum can be provided at outlet 416.

In an alternate embodiment, the tube can extend from the vacuum pump to the container holding the sample, and the tube can be looped and go through liquid nitrogen or other cooling fluid to cool the chamber. Metal balls can be placed inside the tube which is composed of plastic. Thus, the cooled tube functions as the condenser. This reduces the overall size of the device.

In alternate embodiments, instead of inserting the condenser and container containing the biological sample (the first container) into a liquid nitrogen container, a cooling coil is wrapped around condenser 416. Then, by operating a cooler unit coupled to the cooling coil, the condenser 416 is cooled from the outside, thereby also cooling the second internal space 410 within the condenser, relying on heat conduction of the condenser's wall. In such embodiments, unlike the embodiment of FIG. 4 which relies on passive cooling, this relies on active cooling, requiring investment of energy in order to cool the cooling coil.

It should be appreciated that devices of the type of device 200 of FIG. 2, wherein the sample holding container is directly coupled to the condenser, can also be cooled by liquid nitrogen (or other cryogenic fluids) as in the embodiment of FIG. 4. FIG. 5 illustrates an example of such cooling. Freeze drying device 500 of the type illustrated in FIG. 2 has a first container 502 supporting/storing the sample and a condenser 504. The device 500 is inserted into a liquid nitrogen container 506. Reference numeral 508 depicts the liquid nitrogen level inside container 506 to illustrate that device 500 is not submerged in the liquid nitrogen. Similar to device 400, device 500 is also passively cooled by the inherent low temperature of the liquid nitrogen within the container 506. In device 500, outlet 510 is in the upper wall of container 502, and includes a valve 512. Coupling element 118 couples (connects) the vacuum pump (not shown), which is similar to pump 114, to the outlet 510 for applying the vacuum to the closed internal space defined by the internal space in container 502 and internal space in condenser 504.

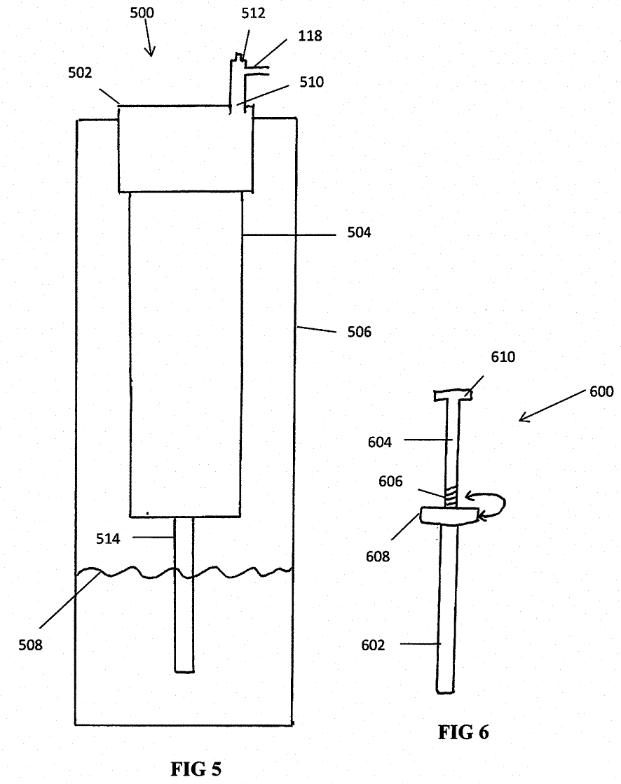

An elevation element 514 is provided to position device 500 above liquid nitrogen level 508. Elevation element 514 includes a post to separate (space) the condenser 504 from the bottom of the liquid nitrogen container 506. Another embodiment of the elevation element is shown in FIG. 6 and designated by reference numeral 600. This elevation element 600 can be utilized to support and elevate the device 500 of FIG. 5 or other devices to keep the condenser and sample holding container out of direct contact with the cryogenic fluid.

Elevation element 600 includes an external member 602, an internal member 604 having a spiral or screw 606 and a piston 608. Piston 608 can be rotated in order to elevate or lower internal member 604 by reducing the exposed length of internal member 604 as it enters into external number 602 via engagement of external threads of screw 606 with internal threads of external member 602. Other structure to provide telescoping arrangement of the internal member are also contemplated to achieve height adjustment of the elevation element.

The elevation element 600 is configured to support a device for freeze drying one or more biological samples. Therefore, it is designed to be placed below the condenser, e.g., condensers 106, 204, 504, described above, or other condensers, to allow changing the elevation of the condenser inside the liquid nitrogen container so that, in some embodiments, it can be raised to a level above the level of the cryogenic fluid so it does not come into contact with the fluid. Elevation element 600 can optionally have a supporting element 610 engageable with a receiving portion, e.g., slot, or other structure of the condenser for additional support. Elevation elements 514 and 600, as well as alternate versions of the elevation element, can be of a fixed height or can be adjustable to support varying heights to adjust to different levels of the cryogenic fluid within the container containing the cryogenic fluid and/or adjust to different distances above the fluid level. Other forms of elevation elements are also contemplated. For example, stand 314 shown in FIG. 3 can be provided as an elevation element to mount the container above (spaced from) the cryogenic fluid line. Adjustment of the elevation level, and therefore the distance from the liquid nitrogen, can adjust/change the temperature of the condenser and the sample.

It is also contemplated that instead of inserting device 500 into a liquid nitrogen container or container containing another cryogenic fluid, it could be wrapped with a cooling coil, thereby actively cooling the device, instead of passively cooling it by liquid nitrogen or other cryogenic fluid.

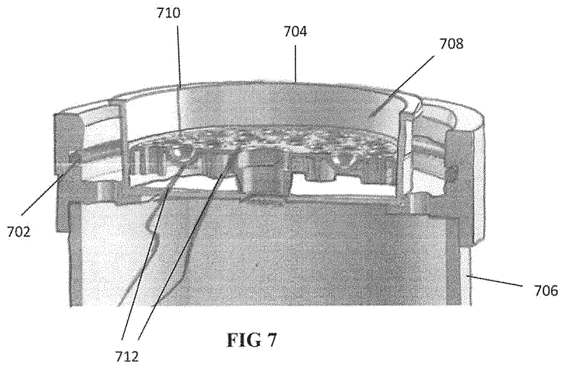

In order to facilitate sublimation in a rate that allows for efficient sublimation of water from the one or more biological samples, various forms of energy could be utilized. In the embodiments of FIGS. 4 and 5, the upper part of the containers 504 and 502 which contain the samples are exposed to outer air, whose temperature is expected to be significantly higher than the temperature above the liquid nitrogen level inside the liquid nitrogen container. However, other ways to achieve higher temperatures are also contemplated, and for sublimation, active application of heat to the container can be provided. For example, in the embodiment of FIG. 7, the device for freeze drying the biological samples includes a first container 704 for holding the samples and a condenser 706 (the upper part is shown). A heating element in the form of a ring or other structure can be positioned outside to surround the container, and the temperature measured by a thermocouple and controlled by a temperature controller. When the heating element is operated it provides the energy required for sublimation. The heating element could be adjacent to or in contact with the container and could extend circumferentially around the entire circumference, or alternatively it could extend less than the full circumference. It should be appreciated that other forms of heating elements, including other configurations are also contemplated. A seal 702 in the form of a silicone 0-ring is shown within a slot or cavity in the container 704 to seal the container for vacuum.

In order to allow sublimation in FIG. 7, it should be appreciated that the one or more biological samples should be exposed to an internal environment of the first internal space 708 of container 704, which communicates with the internal space of the condenser together forming the closed space or chamber. That is, when temperature is lowered within the closed space, the samples should be exposed to the lowered temperature, when pressure is lowered within the closed space, the samples should be exposed to the lowered pressure, etc. Hence, the samples should reside in the first internal space exposed and un-shielded from the internal environment. Accordingly in FIG. 7, tray 710 has a plurality of cavities 712. Each sample may be placed, unshielded, directly in a cavity 712, meaning they are each exposed to the environment within the internal space. It should be appreciated that as discussed herein the samples can be stored in vials placed in the cavities, with the vial exposed to the internal environment of the first internal space of the container, communicating with the internal space of the condenser or alternatively the samples can be placed directly in the cavities (without vials).

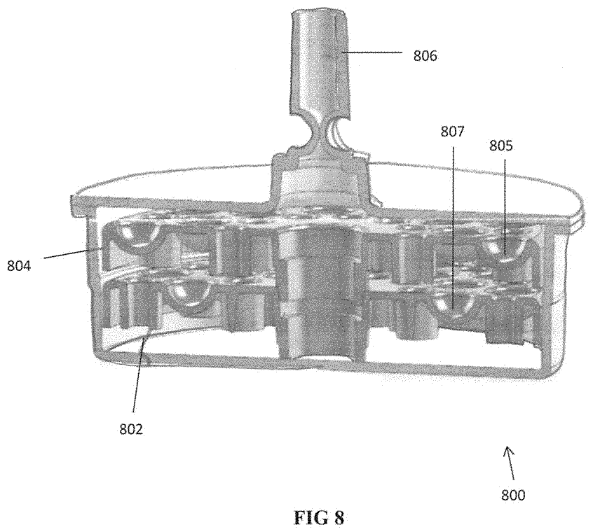

In some embodiments, such as the device of the embodiment of FIGS. 7 and 8, the device is composed of disposable material so it is disposable. The samples are placed in the holder which is disposable and can be heated from the top, e.g., by irradiation or other methods. In other embodiments, such as the embodiment of FIGS. 1, 2, 10C and 10D, the device is not disposable but is sterilizable and vials containing the samples are placed in a metal holder which has contact with the wall of the container and is heated as the wall is heated.

FIG. 8 illustrates one embodiment of an alternate container for storing the samples (the first container). Container 800 has two stacked trays 802, 804, each having a plurality of cavities. More specifically, upper tray has a series of cavities 805 arranged circumferentially and lower tray 804 has a series of cavities 807 arranged circumferentially. For clarity, only one of the cavities of each tray 804, 802 is labelled in the drawing. Coupling element 806 provides communication from the container to a vacuum pump and can include a valve. It should be appreciated that in other embodiments there may more than two trays or only one tray and the trays can be of other configurations. Note the other containers disclosed herein could also have multiple trays, e.g., trays stacked atop each other, with multiple cavities for storing a plurality of biological samples. The samples can be placed in vials as described herein or placed directly on the tray.

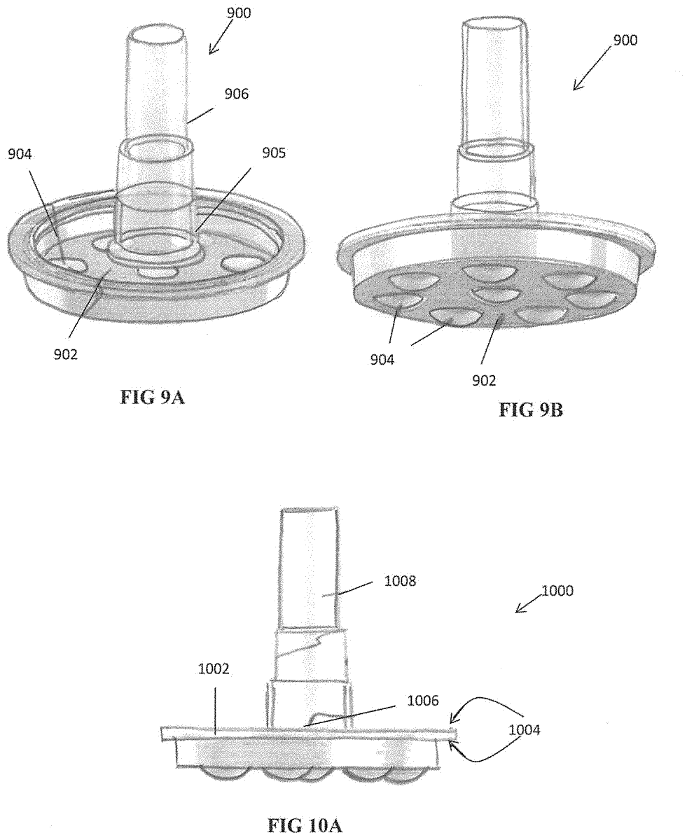

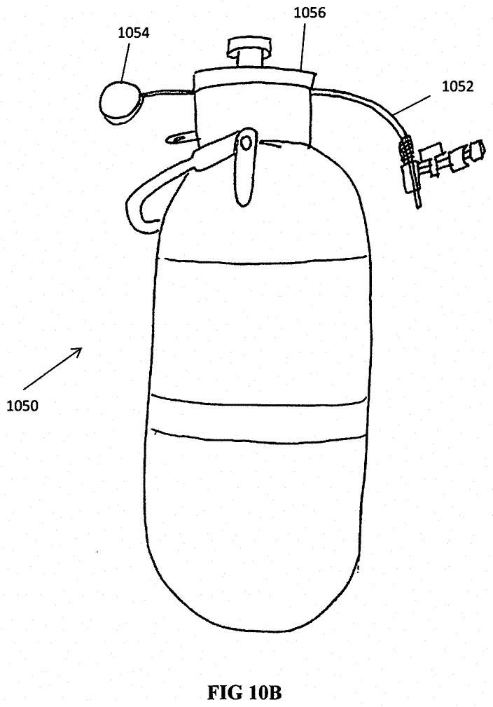

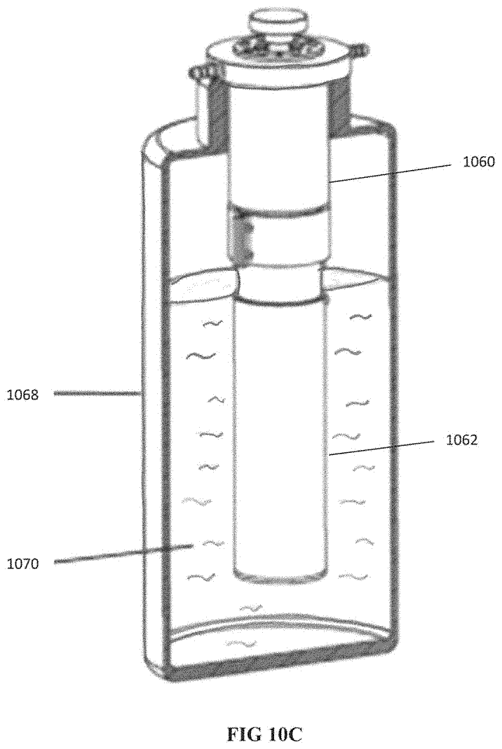

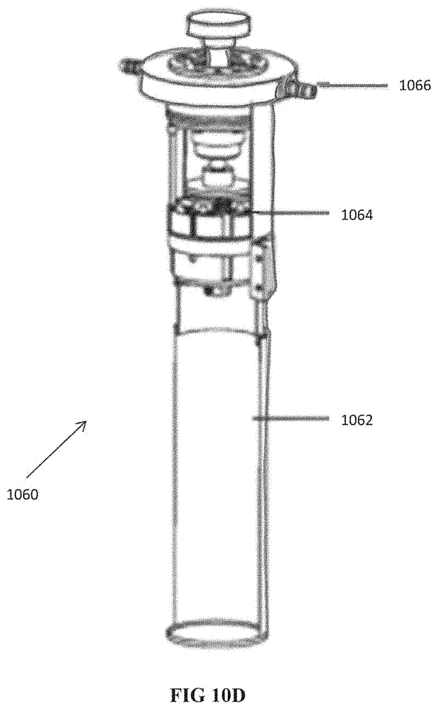

In the alternate embodiment of FIGS. 9A and 9B, instead of holding one or more trays inside the container as in device 800, the bottom wall 902 of the container 900 serves as a tray for holding the biological samples. As shown, the bottom wall 902 has a plurality of cavities 904 for holding the samples. The samples can be placed directly in the cavities as described herein. (Note in other embodiments the samples can be placed in vials and the vials placed in the holder such as in the embodiment of FIGS. 7 and 10C). The outlet 905 is shown extending from the bottom wall 902 of the container and is connected via coupling element (e.g., tube) 906 to a pump to apply the vacuum to the closed internal space formed by an internal space of the container 900 and the condenser (not shown).

FIG. 10A illustrates an alternate embodiment of the container for holding the samples. Container 1000 has a cover 1002 which is placed thereon, and the edges of the cover are welded to the rim of the container wall, as represented by the arrows 1004. The outlet is designated by reference numeral 1006 and tube 1008 extending from outlet 1006 serves as a second coupling element (similar to coupling element 118 described above) communicating with the vacuum pump. After drying the samples and prior to disconnecting the vacuum pump which is connected to coupling tube 1008, in order to seal container 1000 containing the dried samples, tube 1008 can be welded, as illustrated by arrows 1004. The tube 1008 is also sealed, preferably at a narrowed region such as in tube 806 of FIG. 8. As can be appreciated, the samples contained in other containers disclosed herein can be sealed after drying in a similar manner, e.g., by sealing the cover and the tube, or by other sealing methods to maintain a closed environment.

FIG. 10B illustrates an alternate embodiment of the freeze-drying device of the present invention, designated by reference numeral 1050. Device 1050 can be sterilized prior to freeze-drying and can be made of stainless steel. Device 1050 is cooled by liquid nitrogen (or other cryogenic fluid) and has a temperature control, pressure or temperature monitor/gauge 1054, tubing 1052 with valve for the vacuum and a top cover 1056 for sealing the biological samples within the internal chamber or closed space of device 1050.

In the embodiment of FIGS. 10C and 10D, the device 1060 has a vacuum pump entrance 1066, a temperature regulated shelf 1064 for the biological samples and a condenser 1062 in the form of a tubular member. Device 1060 is placed within LN Dewar 1068 containing liquid nitrogen 1070 to lower the temperature in the closed chamber as described herein as the vacuum is applied.

It should be noted that the containers of the embodiments of FIGS. 7-10D can be used in other devices disclosed herein, e.g., devices of the type of devices 100 of FIG. 1 and devices of the type of device 200 of FIG. 2.

It should be appreciated that the container for storing the samples can be of various shapes/configurations and are shown as circular disk-shape in FIGS. 8-10D by way of example.

As explained above, the devices for freeze frying one or more samples comprise a closed internal space. The first container and the condenser are configured to prevent exchange of particles between the closed internal space and an external environment hence the closed internal space turns into a partial vacuum upon actuation of the vacuum pump. However, in addition to facilitating low pressure generation, the prevention of particles' exchange also facilitates sterilization: particles from within the closed internal space (in case of contaminated one or more samples) cannot cross and reach the cold environment, while contaminating particles from the cold environment cannot cross and enter into the closed internal space.

Even further, it should be appreciated that the container for holding the samples and/or the condenser and/or the coupling element connecting the container and condenser (in embodiments where a coupling element is provided to couple the container and condenser) can be made of different materials, among them are polymers and/or metals, with the materials utilized being structurally resistant to low pressure in order to prevent bends under low pressure, thus avoiding putting the biological samples in risk of mechanical damage.

In the embodiments described herein, the condenser is cooled either passively, e.g., by a liquid nitrogen (or other cryogenic fluid) container or actively, e.g., by a cooling element. The environment immediately external to the condenser thereby constitutes a “cold environment,” wherein the cold environment can be the cryogenic fluid's vapors that cool the condenser when the condenser is within the cryogenic fluid container but not in the cryogenic fluid itself or when the condenser is in the cryogenic fluid itself if the condenser is submerged in the fluid, or when the immediate environment is cooled by a cooling coil, etc.

The devices are of sufficiently small size/volume so that the vacuum pressure within the closed chamber can be reached in a very short time. For example, in some embodiments, pressure can reach less than 1 torr, and even 0.5 torr, or even less than 0.5 Torr in a short time period, for example, in under 10 minutes, or in fewer minutes and in some instances in a few seconds as the volume can be as small as 2 liters or as small as 1.5 liters or more preferably as small as 1 liter or even as small as 0.5 liter. Thus, sublimation starts when pressure decreases to 1 torr or 0.5 torr to take away or reduce the ice crystals which can adversely affect the sample. That is the small volume of the internal space, i.e., the space wherein the pressure is reduced via the vacuum pump, enables the desired pressure to be achieved in a rapid way. This enables more rapid start of sublimation.

The small volume of the chamber can be achieved in some embodiments by placement of the condenser and the sample holder in the same chamber.

Further due to the small volume, and rapid cooling and sublimation, the sample and the condenser can be relatively close together in the same chamber. For example, in some embodiments, the distance from the sample to the condenser (cooling element) could be as short as 10 cm or preferably as short as 2 cm, although smaller and greater distances are also contemplated. This short distance still enables the desired freeze-drying, even when the sample is heated for sublimation.

As noted herein, the devices can be of benchtop size which allows for placement in an autoclave for sterilization in some embodiments. Being composed solely of metal in these embodiments, such sterilization can be performed without damaging internal components. Additionally, since in some embodiments the devices can be placed in liquid nitrogen to lower the temperature rather than utilizing a cooling unit, non-metal components, such as tubing within the container, can be avoided within the container to enable sterilization.

Note the devices can be of sufficiently small size to facilitate portability which could be beneficial for liquid nitrogen immersion and/or sterilization.

Due to the small size of the devices, which can be achieved for the reasons discussed above, it is contemplated that in some embodiments, multiple devices can be inserted into the same container of liquid nitrogen. Each device has a pressure monitor and connector for communication with a vacuum pump, which can be the same vacuum pump for multiple devices, and a valve to turn on and off the vacuum application to the chamber within the device. Therefore, when multiple devices are placed within the LN container (or container of other cryogenic fluid), the vacuum need not be activated for all the devices at the same time as the vacuum application to the chamber of each device can be independently controlled. Therefore, the same vacuum pump can be used for all the devices, but the vacuum need not be applied to the devices at the same time as the valve can be shut for the desired devices when vacuum is not desired for the particular device.

Note one or more samples can be held in each device, e.g., the device could hold 4 vials, or 6 vials or another number of vials.

### Methods for Freeze Drying Samples

Methods for freeze drying the biological samples will now be described, the biological samples being of mammalian cells or tissue.

The advantages of drying in various applications are known such as a food preservation technique. In addition to the food industry (e.g., instant coffee, milk and egg powder, dried yeast, etc.) drying is used for pharmaceutical, bacterial, viral, fungal, and yeast preparations. The drying process can be described as follows. In nature, desiccation is the process known as anhydrobiosis or life without water. Anhydrobiosis is an extremely dehydrated state in which organisms show no detectable metabolism but retain the ability to revive after rehydration. Preservation in the dry state is very common in plants (seeds) and many prokaryotes, but it can also be found in some eukaryotes, including rotifers, tardigrades, nematodes, crustaceans, insects and more. What unifies them all is that they are relatively small, they have little or no control over the loss of water from their bodies, and they are generally inhabitants of ephemerally wet habitats. They desiccate at various developmental stages. In the absence of water there can be no biochemical reactions, metabolism declines beyond detectable levels, there is no water to freeze or boil and no active cell processes to be disrupted so they can withstand various environmental extremes. Anhydrobiosis allows animals to survive long periods without water, effectively extending their lifespan and facilitating reproduction or development at the most suitable conditions. Loss of water is gradual and slow, allowing the accumulation of a host of membranes, proteins, and nucleus protective agents to as much as 50% of their dry weight. These protective agents include disaccharides, primarily trehalose, late embryogenesis abundant (LEA) proteins, anhydrin, heat shock proteins and more.

The present invention provides for the desiccation by freeze-drying of sperm cells, oocytes, embryos and reproductive tissues such as ovarian tissue, uterine tissue and testicular tissue. The present invention also provides for the desiccation by freeze-drying of stem cells, hematopoietic stem cells, mesenchymal stem cells, embryonic stem cells, induced pluripotent stem cells either from human source or animal source. Such freeze drying of the present invention can also be used for red blood cells or cell lines. The biological samples are immersed in a special freeze-drying solution/s and are then frozen and dried using the apparatus described herein in conjunction with FIGS. 1-10D and 12-13. The results upon subsequent rehydration after freeze drying are such that can be used for assisted reproduction technologies such as in-vitro fertilization (IVF), Intracytoplasmic sperm injection (ICSI), genetic screening including preimplantation genetic screening (PGS), genetic diagnostic tests including preimplantation genetic diagnosis (PGD), and more.

The entire method for the successful freeze-drying of gametes and reproductive tissues of the present invention will now be described. It includes solutions that are used for such purpose and a freeze-drying device such as the devices described above and illustrated in FIGS. 1-10D and 12-13. The invention provides a freezing process and a drying process. The present invention also provides a rehydration process after the freeze drying process. The gametes and the reproductive tissues can be used for ART including but not limited to cryopreservation, fertility preservation, IVF, ICSI, PGD, PGS and more. This technique provides an effective way of storing the cells and tissues for long period under safe conditions.

Accordingly, the present invention provides a composition for freezing biological samples such as spermatozoa, oocytes, embryos, ovarian tissue, uterine tissue, testicular tissue, etc. comprising a freeze-drying solution (lyophilizing (LYO) solution) based on sugars such as sucrose, sorbitol, glucose, dextran and trehalose and cryoprotectants (CPs) such as dimethyl sulphoxide (DMSO), ethylene glycol (EG), propylene glycol (PG) and macromolecules and proteins such as human serum albumin (HSA), fetal calf serum (FCS), LEA proteins and antioxidants such as Astaxanthin, epigallocatechin gallate (EGCG), Ascorbic acid. The LYO solution can be used in combination, i.e. DMSO and HSA and a buffer solution such as TCM 199, Tris, PBS or Hepes Talp, RPMI-1640, Dulbecco's Modified Eagle Medium or any other known in the field. The LYO solution can be composed of for example DMSO and a carbohydrate or DMSO and a protein.

It has been found that DMSO when used with proteins provides a good lyophilizing solution because it sublimates as it crystallizes at 19 degrees C. When it crystallizes, sublimation can be effected. Upon sublimation, the resulting material typically does not include DMSO, however, even if there is residual DMSO left (because of sublimation of water), if kept below 19 degrees Centigrade, it is still solid and thus doesn't affect the sample, e.g., the cell. Note DMSO will crystallize at 19 degrees C. if it is 100% DMSO, but with solutions of lower percent of DMSO, e.g., 5% or 10%, as can be used in the present invention, by freezing it separates and then sublimates so what is left is DMSO so it will crystallize.

The cells and tissues can be collected in various ways. By way of example, sperm cells can be collected via any method known in the field, including, but not limited to, ejaculation, electro induced ejaculation, testicular sperm aspiration (TESA), biopsies, in-vitro maturation of spermatogonia cells. By way of example, the oocytes can be retrieved by ovum pick up, biopsies, follicular in-vitro maturation. By way of example, embryos can be obtained by IVF means or in-vivo produced embryos can be collected from the uterus. Ovarian tissue can be obtained, for example, via biopsies, transvaginal biopsies, laparoscopy, laparotomy and after ovariectomy. By way of example, uterine tissue can be obtained by biopsies, transvaginal biopsies, laparoscopy, laparotomy and after hysterectomy. Testicular tissue can be obtained, for example, via biopsies.

Note that the foregoing are provided by way of example as other ways to collect the biological samples, i.e., cells and tissues, are also contemplated.

After obtaining the biological material (sample), it is then evaluated based on its origin. For example, sperm cells are usually counted and assessed for their morphology, viability and motility, oocytes and embryos are usually counted and assessed by their morphology, tissues can be taken for live/dead stains or only assessed by morphology. Whichever method for evaluating the cells and tissues are utilized, the biological samples are then immersed in a freeze-drying solution (LYO solution) as described herein. Thus, the method provides for freezing the cells and tissues after being in the LYO solution as described in more detail below.

The method in summary provides a low temperature dehydration process which involves freezing the sample, lowering the pressure and removing ice by sublimation.

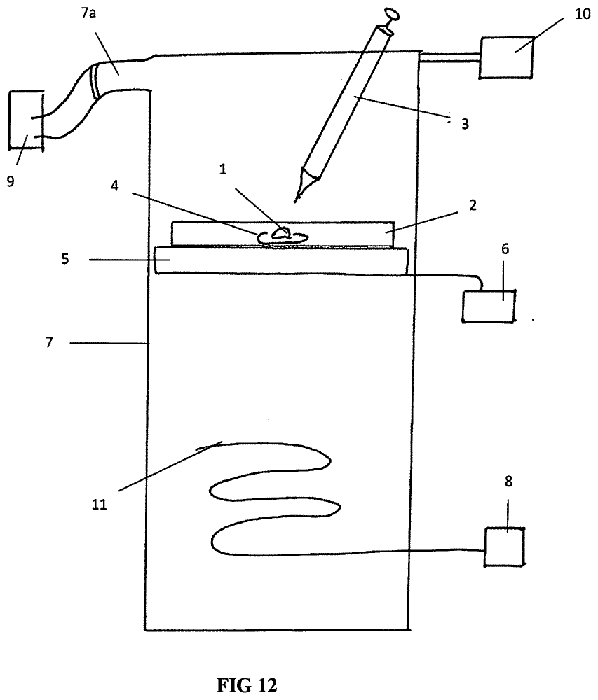

Initially, the freezing of sperm will be discussed with reference to FIG. 12, followed by a discussion of freezing of embryos and oocytes and then a discussion of freezing of stem cells to provide examples of the processes of the present invention.

### Freezing of Sperm

The freezing parameters are illustrated in FIG. 12 which include a sample of sperm, designated by reference numeral 1, immersed in a lyophilzing (LYO) solution having a small volume and deposited on a pre-cooled metal surface 2 of the freeze drying device 7. In FIG. 12, the metal surface 2 is part of the device 7, however, in other embodiments the sperm samples(s) can be deposited on a cooled surface outside the device and then the cooled surface with the samples placed within the device. The drops can be made by pipetting using pipette 3 or by any other method that results in the desired volume, preferably a volume of less than 200 μl, for placement on the metal surface. In the case of a low sperm count, the surface such as a coverslip glass or plastic surface such as Cryotop (Kitazato, Japan) can be marked with a marker 4 to facilitate locating the sperm following rehydration after the freeze drying process. The drops can be placed on a small surface such as a glass or plastic surface prior to freezing or can be frozen on the metal surface directly and after freezing can be collected into a glass vial which is maintained at the same temperature. The cooling rate is determined by the surface temperature and the volume of the drop. In one example for sperm a rapid cooling rate is used by using small drops (e.g., 10-20 μl) cooled on a surface maintained at high sub-zero temperatures (−20° C. to −50° C.) or larger volumes, e.g., (20-200 μl) cooled to temperatures between −50° C. and LN or liquid air temperatures.

### Freeze Drying/Vitrification & Drying of Oocytes and Embryos

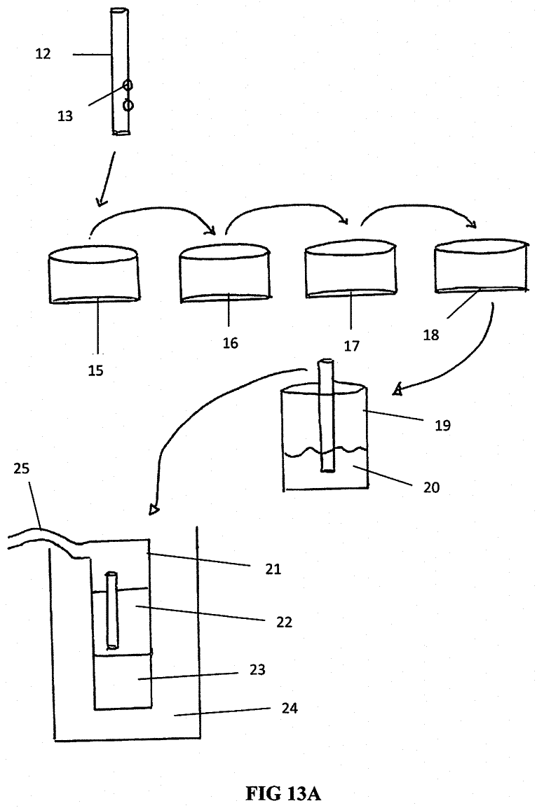

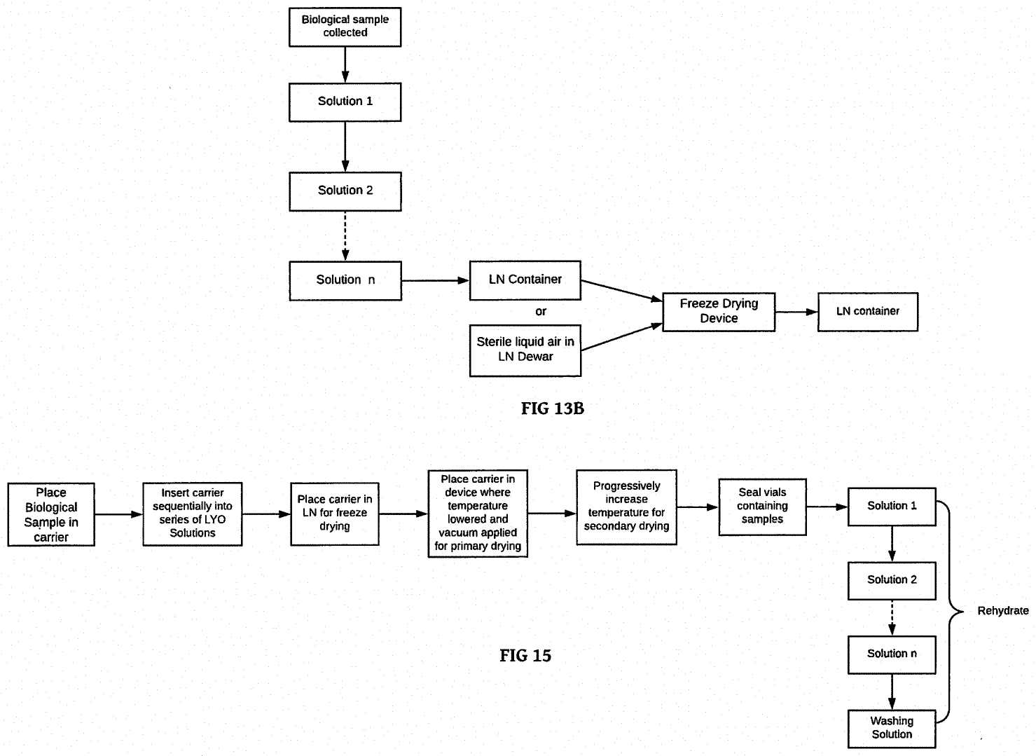

The freezing of oocytes and embryos is illustrated in FIG. 13A and the flow chart of FIG. 13B. Oocytes or embryos can be placed in a straw having a special pod (also called capsule) 12 as described in PCT WO/2017/064715A1, the entire contents of which are incorporated herein by reference. The freezing is accomplished by exposing the cells within the straw gradually to LYO solutions containing cryoprotectants such as DMSO, EG or PG and a protein such as HSA in TCM medium. An example of such LYO solution can be a solution composed of 10% (v/v) DMSO, 10% (w/v) HSA in TCM medium. Such solution can be referred to as 100% LYO solution. The exposure is done by several gradual steps, for example 2-6 steps, of progressive immersion in solutions of progressively increasing LYO solution held in separate containers as depicted in FIG. 13A. For example, the first step can be placement in a container or holder 15 containing a solution that is 25% LYO solution. After a designated period of time, the straw or other sample holder 13 containing the biological sample (oocytes or embryos) is then removed from container 15 and placed in a container or holder 16 containing a solution that is 50% LYO solution. Straw 13 is then removed and placed in a container or holder 17 containing a solution that is a 75% LYO solution and finally removed from container 17 and placed in the holder or container 18 containing a solution that is 100% LYO solution. The exposure time for each solution can be between 1 to 3 minutes at room temperature (RT), although other time periods and/or temperatures are also contemplated. It should be appreciated that the percent LYO solution listed above is provided by way of example, as other percentages can be utilized. Additionally, four containers are shown by way of example, as a fewer or greater number of containers with varying LYO solutions can also be utilized. This is represented in the flow chart of FIG. 13B, where the sample is immersed in solution 1, solution 2 . . . solution n, with n representing the last container of LYO solution of the series of containers 1-n. After withdrawal from container 18, the holder (straw) 13 is plunged into sterile liquid air 20 contained in a LN Dewar 19 or alternatively plunged rapidly into a liquid nitrogen (LN) container (not shown in FIG. 13A but represented in the flow chart of FIG. 13B). The sterile air can be produced in accordance with the method described in U.S. Pat. No. 9,890,995 (produced by FertileSafe, Israel as the Clair device). Subsequently, the holder 13 is removed from LN Dewar 19 and placed in device 21 which is a freeze drying device of the type described above in reference to FIGS. 1-10D. This step is depicted in the flow chart of FIG. 13B. Device 21 has a shelf temperature lower than the glass transition temperature (Tg) of the solution e.g., 90° C., controlled by heater 22 and a condenser 23 set at a lower temperature of device 21 as done with the foregoing devices, e.g., device 100, 200, etc. that is placed into a LN container 24. Note as shown in FIG. 13A and as described above, preferably the sample 13 within the straw 12 is above the liquid nitrogen level in container 24. Connector 25 links the vacuum pump with the internal space of the device 21 to reduce the pressure of the enclosed internal space (chamber). A source of heat energy is provided to the sample within the straw 12 which can be a heater 22 or other heating sources, e.g., irradiation, e.g., infrared lamp.

Note with vitrification and drying, a solution of higher concentration of DMSO, e.g., 30$ can be utilized.

### Freezing of Ovarian, Uterine and Testicular Slices

For freezing, ovarian, uterine or testicular tissues are cut to a small size, e.g., of 1 mm×10 mm×10 mm or a smaller size such as 1 mm×3 mm×1 mm for example. The tissue slice is then exposed to a LYO solutions composed of CPs and sugars in a holding buffer medium as described for oocytes (sequential immersion in progressively increasing LYO solutions), but with a longer exposure time, e.g. 5 minutes, 10 minutes, or longer. Following exposure to LYO solutions the slices are placed on a carrier such as Cryotop (Kitazato, Japan) or inside a straw having a special pod (also called a capsule) as described in PCT WO/2017/064715A1 and cooled as described above for oocytes.

Primary Drying of the Samples after Freezing

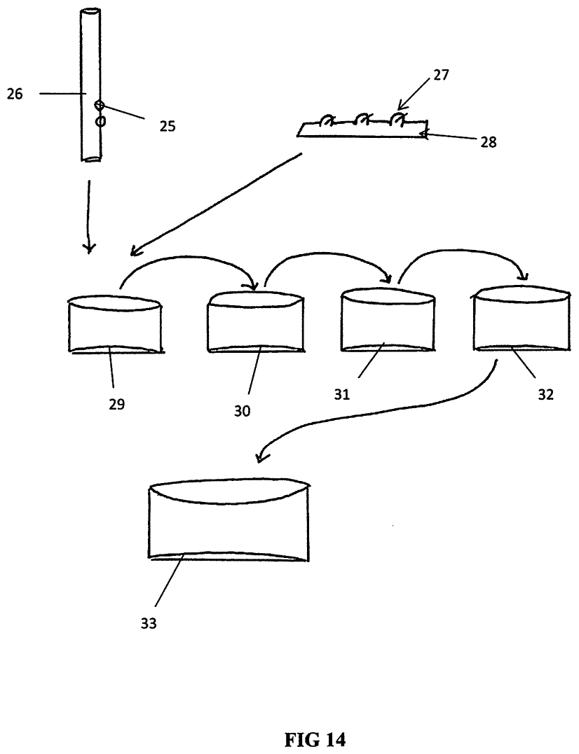

The drying procedure is illustrated in FIG. 12 and depicted in the flow chart of FIG. 15. The drying process is shown in conjunction with a sample of sperm in FIG. 12 but is also utilized with the other biological samples described herein. The cells on the surface or in the vial are placed on the shelf 5 of device 7 which is connected to a temperature controller 6. The metal cooled surface can be part of the device 7, however, or alternatively can be a cooled surface outside the device and then along with the samples placed within the device. The device 7 can be a type of device illustrated in FIGS. 1-10D. The device 7 is closed with the sample contained inside to create a closed internal space and the vacuum pump 9, communicating with the closed internal space via tube 7a, is turned on to create a vacuum in the closed internal space to lower the pressure. The vacuum monitor 10 in communication with the closed internal space closed indicates a pressure, e.g., of 10 mTorr to 100 mTorr, for monitoring the pressure within the closed space (also referred to herein as the closed chamber). The condenser 11 within the device 7 is set to a temperature lower than the shelf temperature and is connected to the cooling system 8 which can be electric or other active cooling mechanism. Alternatively, for cooling, the device can be within a liquid nitrogen container as explained above such as in the embodiment of FIG. 5, to provide passive cooling. Note the vacuum pump 9, vacuum monitor 10, cooling system 8 and temperature controller 6 are shown schematically as conventional pumps, controllers and monitors can be utilized to achieve the respective functions.

Drying at relatively high sub-zero temperatures, referred to as primary drying, is done by maintaining the shelf temperature a bit lower than the Tg′ (glass transition temperature) of the LYO solution used which can in some embodiments be −10° C., −30° C., −50° C. or lower. The vacuum in some embodiments is set to 100 mTorr, 80 mTorr, 50 mTorr or as low as 10 mTorr in some embodiments. The condenser temperature in some embodiments can be set to a temperature lower than the shelf temperature (e.g., between −100° C. and −196° C.).

### Secondary Drying After Primary Drying

Secondary drying, after completing the primary drying, is optional, and is done by increasing the shelf temperature in a stepwise manner e.g., every hour increasing the shelf temperature by 10° C. until reaching the desired storage temperature which can be from LN to RT. At the end of the primary and/or the secondary drying process the vials (or the device) are sealed under vacuum or nitrogen gas can be inserted inside the chamber and sealed with inert gas. Note the samples are kept under the glass transition temperature during drying so melting does not occur. Note a thermocouple can measure the temperature as it is increased and a controller can be used to control such temperature rise. (Note in vitrification, water does not move out in ice crystals).

Rehydration Process after Drying

The rehydration process is illustrated in FIG. 14. The frozen samples that are to be rehydrated can for example be samples of oocytes or embryos frozen in straws or samples of sperm cells frozen as pellets and stored in vacuum sealed vials or tissue slices that can be either in straws or in the carrier placed into a vial for vacuum sealing as described above in the freeze drying process. First the straw 26 containing oocytes or embryos 25 or vials or carriers 28 with drops containing the sperm or tissue slices 27 are taken out (from where they were stored) under nitrogen vapor or in a very rapid manner and the straw 26/carrier 28 is immersed into a warm solution in container 29. The straw 26 or carrier 28 can be immersed in warm solution having a volume of 1 ml for example. When pellets on a carrier or inside a vial are to be rehydrated then the warm solution preferably has the initial volume of the drop, e.g., a pellet/drop of 10 μl will be rehydrated in 10 μl warming solution; if more than 1 drop/pellet is to be rehydrated then the volume should be added together (to total the combined volume of the pellet/drops). The warm solution can be one of the LYO solutions used for freezing and drying. Then the cells/tissues can be moved into a container 30 of 50% of the first solution, removed from container 30 and placed into container 31 of 25% of the first solution and then removed and immersed in container 33 of washing solution, e.g. sperm can be diluted in ICSI medium and can then be injected into the oocytes. (An additional container 32 containing a different percentage of the first solution could also be utilized before the washing solution).

The method of freeze drying and rehydrating the sample is shown in the flow chart of FIG. 15 wherein the carrier containing the sample is sequentially inserted into a series of solutions of progressively increasing LYO solution, the carrier is then placed in liquid nitrogen for freeze drying, the carrier is then removed and placed in a device where the temperature and pressure of the closed chamber are lowered, and the sample is heated. The temperature is then progressively increased for secondary drying, then the vials containing the samples are sealed. The samples are then sequentially inserted into a series of progressively decreasing LYO solutions and then immersed in a washing solution.

### Materials and Methods

### EXAMPLE 1

### Sperm Collection

Sperm samples were collected from n=3 rams of Sarda breed and pooled together to be analyzed as a single sample. Concentration and motility were evaluated using CASA (Ivos, Hamilton Thorne, Biosciences). Only sperm that presented a motility of 85% or more was considered for the experiment. The sperm samples were diluted to a concentration of 50 million sperm/ml in Tris medium and 20% egg yolk added with Lyo A solution containing 0.25M Trehalose and 0.4M Sorbitol or with Lyo B solution, which contains 0.16M Trehalose and 0.26M Sorbitol. Then sperm was cooled to 4° C. at a rate of 1° C./min and then re-evaluated for motility using CASA.

### Freezing

In the experiment, freezing was done by pipetting 10 μl drops of sperm on a coverslip which was precooled to the various temperatures (−10, −25 or −35° C.) and left for 1 hour. Then the coverslip was removed and warmed by placing it on a warm plate (38° C.).

### Freeze-Drying

We used a new device (referred to as Darya, by FertileSafe, Nes-Ziona, Israel). (Note the device is of the type device described herein in conjunction with FIGS. 1-10D which reduced pressure and lowered temperature in the closed chamber). The allows a very rapid decrease in vacuum pressure down to 10 mTorr. It comprises a small metal cylinder with a volume of 1 liter which has two compartments (as in FIG. 1): a condenser is placed on the level of LN₂ in one compartment and the samples are contained in another compartment, regulated by a heater, and connected to a vacuum pump. We set the vacuum to 80 mTorr and the sample heater to various temperatures according to the experimental group. The frozen samples were placed in the lyophilizer after 5 minutes of freezing (at each temperature). This was done very fast (1-2 seconds) since the freezing was done in a very close proximity to the Darya lyophilizer which was open and ready to receive the samples. In every drying cycle between 3-5 slides were placed in the Darya device.

After 1 hour the samples were thawed by placing the coverslip on a warm plate (38° C.) for a few seconds since thawing was very fast.

### Volume and Weight Measurements

Before and after the drying of samples held at temperatures of −10° C. (10 minutes) and −25° C. (1 hour), the amount of volume and the weight of the drops were measured by using a calibrated pipette and a high-precision analytical scales (Sartorius ED224S).

### Cryomicroscopy and Low-Temperature SEM

Cryomicroscopy analyses were performed through an optical microscope equipped with the cryo-stage BCS196 (Linkam, Waterfeeld, UK). Five μl of sperm were cooled in Lyo A and Lyo B (solutions were the same composition but of different concentration of Sorbitol) down to −10° C. or −25° C. and held at these temperatures for 10 or 60 minutes. (Other samples were freeze-dried in Darya for 10 minutes at various temperatures and placed in the cryomicroscope).

Images and video recording were acquired and the ratio of unfrozen/entire area was calculated according to the following equation:

% U=(At−Ac)/At*100

Where U is the unfrozen fraction; At is the total surface area; Ac is the crystals surface area.

More low-temperature analyses were performed using a scanning electron microscope (SEM, Zeiss, Oberkochen, Germany) equipped with a vacuum chamber, which avoided condensation and carefully isolated the sample drop from the environment. Five μl of sperm in Lyo B were placed in the device chamber at −10° C. and held at this temperature and atmospheric pressure for 20 minutes. Likewise, identical conditions of temperature and time were applied in the second experiment, which differed only in pressure settings (10 Pascal=75 mTorr).

### Statistical Analysis

The difference in sperm motility between groups was analyzed using a Student's t-test. Significance was set at P<0.05. Data is expressed as mean±standard deviation.

### Results

Post-Thaw Motility after Freeze-Thawing and Partial Freeze-Drying

After sperm collection and CASA analysis, we found that the motility of spermatozoa was reduced when they were exposed to Lyo A solution. Motility decreased from 86% to 30%, but only temporarily. In fact, after 2 minutes it went up to 60%. Motility remained unchanged after sperm was chilled slowly to 4° C. (61%). The sperm exposed to Lyo B solution did not show any relevant changes and displayed a post-chilling motility of 67%.

After freezing to different high subzero temperatures, −10° C., −25° C. and −35° C., the post-thaw motility (PTM) of the semen exposed to Lyo A was 35%, 36% and 38%, respectively (Table 1).

TABLE 1
Post-thaw sperm mobility after freezing to different temperatures
using two different solutions (Lyo A and Lyo B)

Post-thaw sperm mobility

| Temperature | Lyo A | Lyo B |
|---|---|---|
| Room temperature | 86% ± 2% a | 86% ± 2% a |
| Fresh 4° C. | 61% ± 3.21% b | 67% ± 2% b |
| −10° C. | 35% ± [symbol] .07% c | 64.5% ± [symbol] .25% b |
| −25° C. | 36% ± 4.78% c | 64% ± 4.89% b |
| −35° C. | 38% ± 2.44% c | 31% ± 2.5% c |

[symbol]

indicates data missing or illegible when filed

The semen exposed to Lyo B solution was better than that exposed to Lyo A after freezing and thawing to '10° C. and −25° C. (64.5%, 64%), but showed a decrease at −35° C. (31%), as showed in Table 1.

We recorded the changes occurred in semen when exposed and maintained for 1 hour at high subzero temperatures.

PTM was very low (<10%) when the frozen sperm was maintained at subzero temperatures of −10° C. or −25° C. for 1 hour in both solutions. At −35° C. no motility was recorded. (Table 2).

Finally, freeze-drying for 1 hour at a temperature of −10° C. was not beneficial for semen, in fact PTM was, in both solutions, under 10% (Table 2).

However, when freeze-drying was effected at −2520 C. at 10 mTorr in Lyo A solution, PTM was 35%, while in Lyo B solution it was slightly better with 46.6% (Table 2)

TABLE 2
Post-thaw sperm mobility: (A) after freezing and holding for 1 h at two different temperatures
using two different solutions (Lyo A and Lyo B) and (B) after partial freeze-drying (PFD)
at two different temperatures using two different solutions (Lyo A and Lyo B)

| | A. Post-thaw sperm mobility after holding 1 h | | B. Sperm mobility after PFD | |
|---|---|---|---|---|
| Temperature | Lyo A | Lyo B | Lyo A | Lyo B |
| −10° C. | 3% ± 1.4% a | 3% ± 2% a | 6.5% ± 2% a | 8% ± 1.2% a |
| −25° C. | 3.3% ± 2.8% a | 1.2% ± 2.5% a | 3 [symbol] % ± 4% b | 46.6% ± 2.8% b |

Results are shown as mean ± SD. Different letters (a, b) indicate signifficant differences in sperm mobility between [symbol] and between solutions (p < 0.001) [symbol]
indicates data missing or illegible when filed

PFD was not performed at −35° C.

### Volume and Weight Before and After Partial Freeze-Drying

Volume and weight reduction after freeze-drying at −10° C. with Lyo A was as follows: an initial volume of 80 μl was reduced to 76 μl and the weight, which was initially 92mg, was reduced to 86 mg.

Volume and weight reduction after freeze-drying at −2520 C. with Lyo A was as follows: an initial volume of 80 μl was reduced to 70 μl and the weight, which was initially 92 mg, was reduced to 80 mg.

Volume and weight reduction after freeze-drying at −10° C. with Lyo B was as follows: an initial volume of 80 μl was reduced to 75 μl nd the weight, which was initially 92 mg, was reduced to 84 mg.

Volume and weight reduction after freeze-drying at −2520 C. with Lyo B was as follows: an initial volume of 80 μl was reduced to 65 μl and the weight, which was initially 92 mg, was reduced to 71 mg.

### Low-Temperature Cryomicroscopy

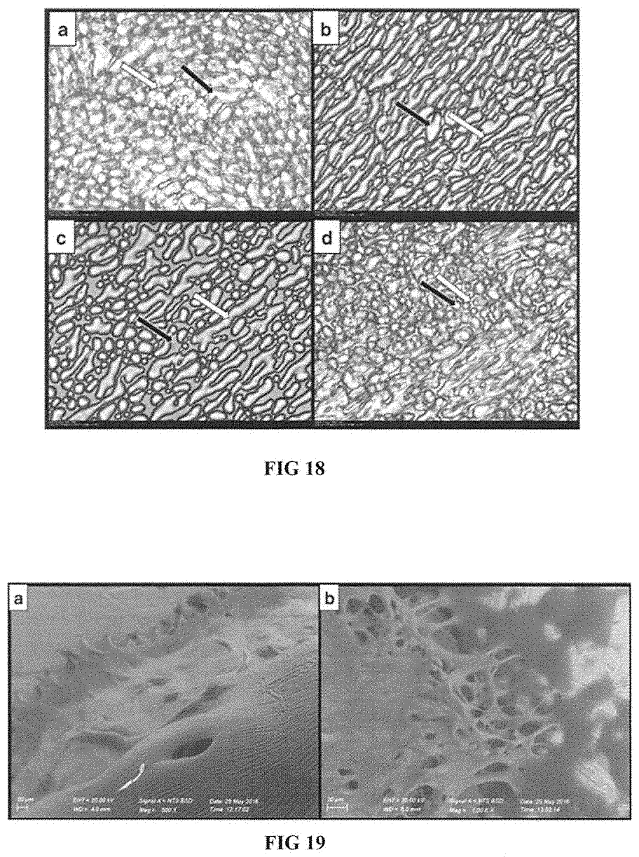

There were clear differences in the amount of the unfrozen fraction (U) and in ice-crystal size shown in cryomicroscopy data collected from ram semen samples held for 10 minutes at −10° C., with and without previous freeze-drying. The U rate in Lyo A after freeze-drying (U=28%, FIG. 18-d) was almost double compared to the not freeze-dried sample (19%, FIG. 18-b).

A more evident difference was shown in Lyo B samples, where the freeze-dried solution exhibited a very large U (30%, FIG. 18-c) compared to the not freeze-dried sample (U=13%, FIG. 18-a). In addition, much smaller ice crystals were found in freeze-dried samples (FIG. 18-c, 18-d) than in those not freeze-dried (FIG. 18-a, 18-b).

### Low-Temperature Scanning Electron Microscopy (SEM)

SEM analysis of Lyo B samples exposed to sublimation process under vacuum pressure (75 mTorr) and held at −10° C. for 20 minutes showed smaller ice crystals (FIG. 19-b) compared to the large crystals found in samples cooled at atmospheric pressure (FIG. 19-a).

### EXAMPLE 2

Title: Freeze dried human sperm showed a high DNA integrity after UV irradiation in compared to frozen sperm.

Study question: Comparison of the DNA integrity of a) frozen human sperm to b) freeze/drying (lyophylized) human sperm, following UV irradiation.

Summary answer: Freeze dried human sperm maintain the high DNA integrity compared to frozen sperm.

What is known already: Recently it was shown that mice sperm that were preserved in the dry state for 9 months in a space station and exposed to cosmic irradiation showed only slightly DNA damages which was repaired by oocytes cytoplasm and resulted with normal offspring.

Study design, size, duration: Human sperm were collected and were frozen and freeze dried. DNA integrity using Hallosperm were measured on 1. Fresh control, 2. Freeze dried and rehydrated, 3. Freeze dried irradiated and rehydrated 4. Frozen irradiated and thawed.

### Participants/Materials, Setting Methods:

Fresh human sperm samples donated to research (n=3) were first diluted 1:1 (v/v) in lyophilization solution (LyoS: a-MEM Eagle-0.25M sucrose, 0.25M trehalose and 0.6% (w/v) HAS in α-MEM Eagle medium) and then cryopreserved by direct immersion into sterile liquid air (Clair, Fertilesafe, Israel). Freeze dried pellets were kept in vials at 4 C and frozen pellets were kept in glass vials at liquid nitrogen. Four groups were used: 1. Fresh control. 2. Freeze dried and rehydrated. 3. Freeze dried and irradiated before rehydration 4. Frozen and irradiated before thawing. Freeze drying was done using freeze sterile drying device (Darya, FertileSafe, Israel). Following the frozen pellets or the dried pellets were irradiated using UV for 30 minutes. Dried sperm were rehydrated using (0.2 mL of LyoS warmed to 37 C) and frozen pellets were thawed on warmed (37 C) microscopic slide. DNA integrity was evaluated using Hallosperm kit.

### Main Results and the Role of C4hance:

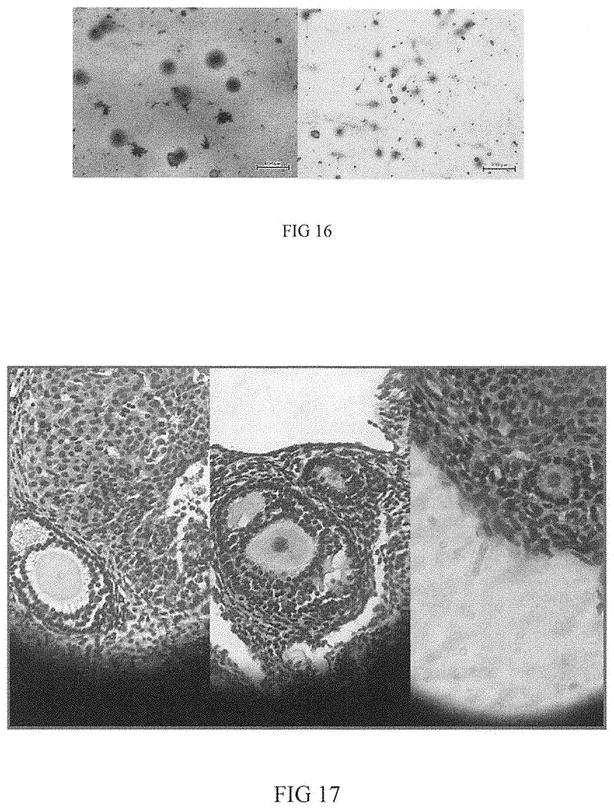

Fresh human sperm showed 85% DNA integrity (84/98). Rehydrated human sperm showed no significant cell loss and no decreased DNA integrity. Fresh sperm concentration was 10·10⁶ cells/ml and motility was more than 50%, DNA integrity was 81.06%±9.2%. Post thaw motility (without drying) was 65-80% of the fresh (normalized) same specimens. After drying and rehydration concentration of the group that was rehydrated with LyoS was 5.375·10⁶ cells/ml. Irradiated freeze dried human sperm showed DNA integrity of 84%±8.1% and concentration of 5·10⁶ cells/ml. The DNA integrity of irradiated frozen sperm was significantly (P<0.05) lower and only of 9%±15% had integrated DNA, while concentration was slightly lower 4.5·10⁶ cells/ml. The morphological observation of irradiated frozen sperm was much different than the irradiated dried sperm; tail and membrane were lost after irradiation in the frozen state and DNA showed larger hallow. FIG. 16 shows Hollowsperm staining of irradiated frozen sperm (left) and irradiated freeze dried sperm (right).

These results show that there was no cell loss and no additional damage to the DNA integrity due to the drying process and irradiation at the dry state. From previous animal studies with dried sperm if there is no damage to the DNA then the sperm can be used for fertilization resulting with live, normal offspring. Human sperm freeze-drying is a revolutionary technology that will allow the long term storage of sperm at room temperature protected from UV irradiation.

### Limitations, Reasons for Caution:

This study was done on low number of samples and is needed the verification of normal embryos development following ICSI.

### EXAMPLE 3

### (With Ovarian Tissue)

Mice ovaries were dissected and cut to 1×10×5 mm. The ovarian slices were exposed to Lyo solution containing 10% DMSO, 10% HSA in PBS. Following exposure to LYO solutions the slices were placed inside a straw having a special pod (also called capsule) as described in PCT WO/2017/064715A1 and cooled in a rate of 1C/min using the Darya device.

The drying procedure is illustrated in FIGS. 12 and 13A. The cells on the surface or in the vial were placed on the shelf. The vacuum monitor indicates a pressure of 10 mTorr and the condenser is set on a temperature of −115 C. Drying at relatively high sub-zero temperatures, namely primary drying, was done by maintaining the shelf temperature a bit lower than the Tg′ of −30° C. Secondary drying with Darya was done by increasing the shelf temperature every hour by 10° C. until reaching the desired storage temperature which can be from LN to RT. At the end of the primary and or the secondary drying process the vials were sealed under vacuum until rehydration. The tissue were rehydrated in 37 C warm Lyo solution and then fixed in 2% formaldehyde.

Results showed that after rehydration and staining with Haematoxylin Eosin we did not see any different in the histology between fresh control and freeze dried tissue (see FIG. 17).

### Method for Freeze-Drying Stem Cells

A method for freeze drying sperm, oocytes embryos, reproductive tissues, etc. is discussed above. The freeze drying method, along with the rehydration process, described above can also be utilized for stem cells in accordance with the present invention.

Stem cells are undifferentiated cells that when manipulated in the laboratory can be differentiated into different cell types according to the stem cells origin. They have been used in a clinical setting for many years. Haematopoietic stem cells have been used for the treatment of both haematological and non-haematological disease, while more recently mesenchymal stem cells (MSC) derived from bone marrow have been the subject of both laboratory and early clinical studies in the field of regenerative medicine. Embryonic stem cells (ESC) are pluripotent cells, capable of forming stable cell lines which retain the capacity to differentiate into cells from all three germ layers. This makes them of special significance in both regenerative medicine and toxicology. Induced pluripotent stem (iPS) cells may also provide similar applications as embryonic stem cells without some of the confounding ethical issues surrounding them. An essential pre-requisite to the commercial and clinical application of stem cells are suitable cryopreservation protocols for long-term storage.

Currently cryopreservation for all stem cells is done by cooling the cells and storing the cells in liquid nitrogen or nitrogen vapor. The cryopreservation can be done by slow freezing (which employs relatively low cryoprotectants concentrations and slow cooling rates), which is mainly used for hematopoietic and mesenchymal stem cells or by vitrification (a process of solidifying a sample without the creation of ice crystals), done mostly by using high cryoprotectants concentrations and high cooling rates) which is mainly used for ESC and iPS. However, these preservation methods come with a heavy price tag. The disadvantages of such preservation methods were discussed above with reference to sperm embryos, oocytes, reproductive tissues, and such disadvantages are fully applicable to use of such methods for stem cells. Thus, maintaining cryopreserved stem cells in storage under LN has high maintenance costs, requires dedicated specialized facilities and trained staff, shipping is cumbersome and very expensive, there is a need for guaranteed and continuous LN supply and there is a risk of tank malfunction. In addition, there is a risk of pathogen transmission between samples due to a contaminated sample. Also, the industrial production and distribution of LN and the energy demands of the dedicated storage facilities have a serious environmental impact, leaving a massive carbon footprint. For all these reasons, the preservation of stem cells in accordance with the present invention is extremely beneficial.

The process of desiccation for freezing, also known as anhydrobiosis or life without water, is discussed above and for brevity is not repeated herein.

Described below is a method for the desiccation by freeze-drying of stem cells, including but not limited to hemopoietic stem cells, MSC, ESC and iPS. The cells are immersed in a special freeze-drying solution/s and are then frozen and dried using an apparatus of the type described in conjunction with FIGS. 1-10D and 12-13. The results upon rehydration are such that will enable the growth of such cells in culture and maintain their ability to differentiate.

An entire method for the successful freeze-drying of stem cells in accordance with the present invention will now be described. It includes solutions that are used for such purpose and a freeze-drying device. The invention provides the freezing process, the drying process and the rehydration process. The stem cells can be used for research or for clinical use and regenerative medicine.

Accordingly, the present invention provides a composition for a lyophilization solution/s (LYO solution), as described above, based on sugars such as, sucrose, sorbitol, glucose, dextran and trehalose and cryoprotectants (CPs) such as dimethyl sulphoxide (DMSO), ethylene glycol (EG), propylene glycol (PG) and macromolecules and proteins such as human serum albumin (HSA), fetal calf serum (FCS), LEA proteins and antioxidants such as Astaxanthin, epigallocatechin gallate (EGCG), Ascorbic acid. The LYO solution can be used in combination i.e., DMSO and HSA and a buffer solution such as TCM 199, PBS, RPMI-1640 or Hepes Talp or any other known in the field.

The cells which are usually grown in culture in the laboratory are collected according to the laboratory protocol which depends on the exact type of cells and subsequent culture system. The biological material is then evaluated for its concentration i.e., cell number per 1 ml. They may or may not be stained for assessing viability. The present invention provides accordingly a method for freezing or vitrifying cells after being in the LYO solution as described hereinafter.

### Freezing of Cells

The device of FIGS. 12 and 13A are utilized for the stem cells in accordance with the present invention. Thus, the freezing/vitrification parameters/process can be appreciated by return reference to FIG. 12 showing a sample of cells immersed in s LYO solution having a small volume 1 on, as described in the embodiment above, a pre-cooled metal surface 2 of device 7 (The sample initially placed on the cooled metal surface outside the device or placed on the cooled metal surface already in the device). The drops can be made by pipette 3 or any other method that preferably results with a volume of less than 200 μl The drops can be placed on a small surface such as glass or plastic surface prior to freezing or can be frozen on the metal surface directly and after freezing can be collected into a glass vial which is maintained at the same temperature. The cooling rate is determined by the surface temperature and the volume of the drop, e.g., using a rapid cooling rate by using small drops (10-20 μl) cooled on a surface maintained at high sub-zero temperatures (−20° C. to −50° C.) or larger volumes e.g. (20-200 μl) cooled to temperatures between −50° C. and LN or liquid air temperatures.

It should be noted that for stem cells in some embodiments, slow freezing rate is utilized. For example, 1-10 C/min from seeding temperature of −7 C to 40 C and then applying a vacuum.

### Vitrification of Cells

Successful vitrification depends on three main factors: Sample's volume, sample's viscosity and the cooling rate. The three parameters interact according to the following equation:

Probability of vitrification=(viscosity×cooling or warming rate)/volume

Therefore the higher the sample's viscosity and cooling rate and the smaller the volume, the probability for vitrification to occur increases.

For the purpose of lyophilization the cells can be vitrified prior to being put on the metal plate.

The vitrification of ESC usually requires the stepwise exposure of ESC colony fragments to two vitrification solutions of increasing cryoprotectant concentration, the common components of which are DMSO and EG. Described herein is one example of such a protocol that can be used, and it should be appreciated, that this is described in a non-limiting way by way of example. That is, alternative methods for vitrification can be utilized. An example for a vitrification protocol for ESC is as follows: Two LYO solutions (LS) are used, both based on a holding medium which included DMEM containing HEPES buffer supplemented with 20% fetal bovine serum (FBS). The first LS (LS1) is composed of 10% DMSO and 10% (EG). The second vitrification solution (LS2) includes 20% DMSO, 20% EG and 0.5 M sucrose. Four to six clumps of ES cells are first incubated in LS1 for 1 minute, followed by incubation in LS2 for 25 seconds. Samples are then washed in a 20 μl droplet of LS2 and placed within a droplet of 1-2 μl of VS2. The clumps are loaded into the end of the carrier such as a Cryotop carrier. The carrier can be directly submerged into LN or to sterile liquid air using the Clair device of U.S. Pat. No. 9,890,995 as mentioned above. An alternative carrier can be used by loading the cells with LS1 into a straw having a special pod (also called capsule) as described in PCT WO/2017/064715A1 (12) for 1 minute and then using an absorbing paper such as a Kimwipe the excess solution is removed and then the straw is inserted into LS2 for 25 seconds followed by absorbing the solution and immediate immersion into LN or sterile liquid air using the Clair device.

Following the straws plunged rapidly into LN or sterile liquid air 20 produced by a LN Dewar 19, they are placed in device 21 (see e.g. FIG. 13A) with shelf temperature lower than the Tg of the solution e.g. −90° C. (to avoid devitrification damages) controlled by heater 22 and a condenser 23 set at a lower temperature as placed into a LN container 24.

### Primary Drying

The drying procedure utilized for the stem cells in device 21 is the same as in FIGS. 12 and 13A. The cells on the surface or in the vial are placed on the shelf 5 which is connected to a temperature controller 6. The device 7 is closed and the vacuum pump 9 starts to operate. The vacuum monitor 10 indicates a pressure for example of 10 mTorr to 100 mTorr. The condenser 11 is set on a temperature lower than the shelf temperature and is connected to the cooling system 8 which can be active cooling such as electric or alternatively passive cooling such as container 24 of liquid nitrogen. Primary drying is done by maintaining the shelf temperature a bit lower than the Tg′ of the LYO solution used which can be for example −10° C., −30° C., −50° C., −70° C., −90° C. or lower. The vacuum is set to 100 mTorr, 80 mTorr, 50 mTorr or lower to 10 mTorr. The condenser temperature is set to a temperature lower than the shelf temperatures (e.g., between −100° C. and −196° C.).

Secondary drying, which is optional, with device 7 (after completing the primary drying) is done by increasing the shelf temperature in a step wise manner, e.g., every hour increasing the shelf temperature by 1° C. to 10° C. until reaching the desired storage temperature which can be from LN to room temperature (RT). At the end of the primary and or the secondary drying process/processes the vials (or the device) are sealed under vacuum or nitrogen gas can be inserted inside the chamber and sealed with inert gas.

### Rehydration Process

The rehydration for the stem cells performed in the manner of FIG. 14 (and flow chart of FIG. 15) described above in conjunction with other biological samples. The frozen samples that are to be rehydrated can be frozen in straws or in the carrier and be placed into a vial for vacuum sealing. First the straw(s) 26 containing stem cells 25 or carrier(s) 28 containing stem cells 27 are taken out (from where they were stored) under nitrogen vapor or in a very rapid manner and the straw/carrier is immersed into a warm solution in container 29. The straw 26 can be immersed in warm solution having a volume of 1 ml. When pellets on a carrier or inside a vial are to be rehydrated then the warm solution preferably has the initial volume of the sample, e.g. a pellet/drop of 10 μl will be rehydrated in 10 μl of warming solution, if more than 1 drop/pellet is to be rehydrated then the volume should be added together (to correspond to the total volume of all drops/pellets). The warm solution can be one of the LYO solutions used for freezing and drying. Then the cells can be moved into 50% of the first solution in container 30 and then into 25% of the first solution in container 31 (in the same manner as described above) followed by the final solution in container 32, e.g., the cells can be diluted in a medium and can then be injected into a patient or continue to grow in culture.

Thus, as can be appreciated, the methods, devices and systems described in detail herein for freeze drying and rehydrating of oocytes, embryos and sperm are applicable to freeze drying and rehydrating stem cells.

Freeze Drying Mononuclear Cells Derived from Human UBC—2nd & 3ed Experiments Aim:

The aim of these experiments was to freeze-dry (lyophilize) mononuclear cells (MNC) derived from human umbilical cord blood (UCB) using the FertileSafe Darya device (of FIG. 10D). In a preliminary study in which MNC were lyophilized with 4 different solutions (IMT-2 and IMT-3 either based on PBS or on RPMI) using the Darya device best results were achieved with IMT-2 (RPMI) solution. These results were based on cell counts and trepan blue dye.

In the following experiments we wanted to better evaluate the survival of cells using live/dead fluorescent stains (FITC/PI) which have a higher accuracy in determining the viability as well as evaluating the percentage of the apoptotic cells using Annexin V-FITC and PI fluorescent stains. Both assays (viability and apoptosis) were evaluated using a fluorescence-activated cell sorting (FACS) device.

In these experiments MNC were lyophilized using IMT-2 (RPMI) solution and then samples were either stored at −80° C. or in a dry shipper and delivered to an external lab Hadassah Medical center in Jerusalem for the FACS evaluations.

### Experiments Description:

UCB collected at Sheba Medical center on Jun. 8, 2018 at 0345 was received on the same day to Fertilesafe's lab (Exp.2). Another UCB unit which was collected on Aug. 8, 2018 at 2100 at the Sheba Medical Center was received to Fertilesafe's lab the following day on Sep. 8, 2018 (Exp.3). All units were kept at room temperature (RT) from collection until they were treated.

The blood was separated on a Ficoll Histopaque-1077 gradient by placing 3 ml of Ficoll in a 15 ml tube and above it 3 ml of UCB. Centrifuged for 30 minutes at 1000 g with no breaks.

Then the MNC layer was taken and placed in another 15 ml tube. 3 MNC layers were collected to one 15 ml tube and about 8 ml of PBS (Ca & Mg free) was added. A total of 4 tubes were done in the same manner. The tubes were centrifuged for another 10 minutes at 300 g. The supernatant was removed and another 10 ml of PBS (Ca & Mg free) was added, cells aspirated and another spin at 300 g for 10 minutes was done. Then, the supernatant was removed, and each pellet was re-suspended with IMT-2 (RPMI) solution composed of 0.945 mg/ml EGCG, 0.1M trehalose in RPMI.

From the second experiment 2 vials containing 0.5 ml each of cells suspension were freeze-dried and in the 3rd experiment 4 vials with 0.5 ml cells suspension each were freeze-dried.

Freezing was done by placing the samples within a metal block in the −20° C. freezer for about 15 minutes, when sample reached −2.5° C. seeding was done using a pre-cooled needle placed in LN. After samples were frozen (indicated by reaching −10° C.-−15° C.) they were transferred to the Darya device at a shelf temperature of −35° C. and a vacuum pressure of 200 mTorr and condenser at −100° C. for 72 hours. In the 3rd experiment after 72 hours the cells were left in the Darya device for an additional 24 hours at a shelf temperature of −69° C.

After 72 hours (Exp. 2) the Darya device was opened, vials were vacuum sealed and the 2 vials were placed at −80° C. for 4 days and then they were taken within a dry shipper (˜−155° C.) to the lab in Jerusalem. After 96 hours in the Darya device (Exp. 3) the vials were removed and treated as follows: 2 vials were vacuum sealed and placed in the dry shipper, 1 vial was rehydrated with 450 μl of distilled water heated to 37° C. a sample was taken for Trypan Blue and cell counts evaluations and the rest was left in the vial sealed and placed in ice. The last vial was vacuum sealed and placed on ice.

All 6 samples were taken to Jerusalem. The 5 vials that were still dry were rehydrated there by adding 450 μl of distilled water warmed to 37° C. into each vial. All 6 vials underwent FACS evaluations for viability using propidium iodide (PI) as a marker for dead cells and for apoptosis using the Annexin V-FITC conjugated marker for cells that had their membrane compromised (it attaches to exposed phosphatidylserine sites) and PI to label the dead cells.

Cells concentrations were counted using a hemocytometer and dyed with Trypan Blue in order to determine viability before and after rehydration.

Cells viability was calculated as follows=(live cells/total cells)×100

Live cells after rehydration was calculated as follows=(viable cells after rehydration/viable cells prior lyophilization)×100

### Results:

TABLE 1
A list of the vials that were freeze-dried in the two experiments
and how they were processed until evaluated at Jerusalem.

| Vial# | Treatment |
|---|---|
| 1 | Exp. 3 - rehydrated at Fertilesafe (a sample went to TB stain and |
| | cell counts) and transferred at 4° C. to Jerusalem |
| 2 | Exp. 3 - left dry and transported at 4° C. to Jerusalem |
| 3 | Exp. 3 - left dry and transported in the dry shipper to Jerusalem |
| 4 | Exp. 2 - stored 4 days at −80° C. then transported in dry shipper |
| | to Jerusalem |
| 5 | Exp. 2 - stored 4 days at −80° C. then transported in dry shipper |
| | to Jerusalem |
| 6 | Exp. 3 - left dry and transported in the dry shipper to Jerusalem |

TABLE 2
Shows the cells concentrations and the cells
viability of fresh samples from Exp. 2 & Exp.
3 and of the rehydrated sample 1 from Exp. 3.

| | Cells concentrations | | | |
|---|---|---|---|---|
| | (·10⁶ cell/ml) | | Cells Viability (%) | |
| | Exp. 2 | Exp. 3 | Exp. 2 | Exp. 3 |
| Fresh | 2.2 | 0.713 | 100 | 100 |
| After | N/A | 1.4 | N/A | 81.07% ± 5.9% |
| rehydration | | | | |

TABLE 3
Depicts viability percentages according to
fluorescent stains (PI/FITC) where PI indicates dead cells.
FACS viability results according to PI/FITC stains

| Sample # | 1 | 2 | 3 | 4 | 5 | 6 |
|---|---|---|---|---|---|---|
| % Viability | 63.97 | 55.7 | 55.7 | 82.63 | 82.39 | 67.03 |

### Discussion:

In the above experiments we can see that according to the FACS the viability ranged between the samples from ˜55% to ˜82% live cells. The sample that was stained at FertileSafe (Sample #1) using TB showed 81% viability whereas the FACS results showed ˜64%. This difference is mainly due to a false positive characteristic attributed to the TB stains whereas PI being a fluorescent label that enters the nucleus only of damages cells has a much more accuracy to it.

Nevertheless, it shows that after freeze drying the majority of cells are viable. The main differences in the results are seen between the experiments (Exp. 2 and Exp. 3). Experiment 2 resulted with similar and higher viabilities of about 82% (according to FACS results) in both samples (Samples #4 & 5), whereas in Exp.2 viability was between 55.7% to 67%. We think that these differences in post rehydration viabilities results from the difference in the fresh units received. We have seen in our previous work that although the fresh cells are all alive they deteriorate as time passes between collection time and freeze-drying time. In the third experiment the UCB unit was received the next day after the delivery and we also saw that the cells count after separation was lower; 0.713 million cells per ml (Exp. 3) compared to 2.2 million cells per ml (Exp.2) which is more what we used to receive after the separation protocol in our previous work.

Furthermore, regarding the Annexin V FACS data, since this was done with no fresh control we cannot interpret the results. When looking at the FACS images it is not understood which proportion of the cells is apoptotic and which is alive. It is clearer what is the necrotic cells population but lacking a control we cannot deduce anything or even know if the “gates” he chose for the FACS are the correct “gates”.

If these work proceeds the fresh units must be evaluated as well in order to better understand and evaluate the results after rehydration.

As for evaluation of storage which were done we can see that storing at −80° C. for 4 days and transporting in dry shipper did not damage the samples as seen by the high viabilities (82%) of samples 4 & 5 from Exp. 2.

In the 3rd experiment we saw that the viability of the sample (#1) which was rehydrated at our lab and transported at 4° C. was 63.9% was similar viability to the samples stored in the dry state and transported in the dry shipper (#3 & 6) which were 55.7% and 67%, respectively. Sample #2 which was transported dry at 4° C. had 55% viability after rehydration. In this experiment it doesn't seen that transportation or storage conditions have damaged the cells. As stated above we believe that the lower viabilities in these experiments are a result of differences between the UCB units received the processes they underwent.

### Report on Freeze Drying Mobilized Stem Cells

Cells from Shiba hospital (under IRB) were collected by Leukapheresis, 600M cells were Found in 2 ml. The cells were diluted with freezing solution to concentration of 10M/ML or into 2 different freeze-drying solutions. The freezing was done with 10% DMSO in RPMI medium (control) in two sessions (F1 and F2). All procedures is of freezing and drying were done according to the method described above.

Two freeze drying solutions were tested Dry2 are with 0.1M Trehalose and 1 mg/ml EGCG in RPMI medium, while DDMSO is 5% DMSO and 10% HSA in RPMI Medium.

Results shows that DDMSO viability after 72 h culture the same number of cells and live cells after 1 week with small number of colonies (CFU).

In addition Dry2 present CD3-CD8 and CD3-CD4 following 1 week of culture After 1 week

| Group | Live | CD3 CD8 | CD3 CD4 |
|---|---|---|---|
| F2 (cont) | 5 | 0 | 0 |
| Dry2 | 14 | 1 | 3 |
| DDMSO | 3 | 0 | 0 |

Although the apparatus and methods of the subject invention have been described with respect to preferred embodiments, those skilled in the art will readily appreciate that changes and modifications may be made thereto without departing from the spirit and scope of the present invention as defined by the appended claims.

1. A method for freeze-drying a biological sample of mammalian cells or tissue, the method comprising placing one or more of a droplet, or a slice of the biological sample on or in a structure to decrease a temperature of the biological sample and with the biological sample in a closed chamber applying a vacuum to the chamber to lower a pressure within the chamber, cooling to lower a temperature within the chamber and applying heat to the biological sample within the chamber.

2. (canceled)

3. The method of claim 1, wherein the structure is a pre-cooled surface and the biological sample is placed on the pre-cooled surface outside the chamber and the pre-cooled surface is subsequently placed within the chamber.

4. The method of claim 1, wherein the biological sample includes one or more of stem cells, hematopoietic stem cells, mesenchymal stem cells, embryonic stem cells, induced pluripotent stem cells.

5. (canceled)

6. The method of claim 1, wherein the biological sample is diluted in a lyophilizing solution.

7.-12. (canceled)

13. The method of claim 1, fu4ther comprising the step of controlling the temperature within the chamber.

14. The method of claim 1, wherein said cooling the chamber comprises the step of inserting at least a part of the chamber in a container of cryogenic fluid.

15.-17. (canceled)

18. The method of claim 1, wherein the biological sample is cooled at a slow rate to seeding temperatures between −3 C and −10 C and further to subzero temperature between −7 C and −50 C.

19.-21. (canceled)

22. A method for freeze-drying and rehydrating of a biological sample comprising comprising:
a) inserting a carrier comprising said biological sample into a first LYO solution;
b) removing the carrier from the first LYO solution and placing the carrier in a second LYO solution, the second LYO solution being different than the first LYO solution;
c) placing the carrier in a chamber, the chamber having a container for holding the biological sample and a condenser for lowering the temperature within the chamber;
d) removing the carrier from the device and inserting the carfrier into a third solution and subsequently removing the carrier from the third solution and inserting the carrier into a fourth solution to rehydrate the at least one biological sample; and
e) freeze drying the biological sample by applying a vacuum to the chamber to lower the pressure within the chamber, lowering the temperature within the chamber, and heating the at least one biological sample.

23. The method of claim 22, wherein the biological sample is rehydrated in a rehydration solution at temperature of 22° C., 30° C. or 37° C. which contain sugars comprising one or more of Sorbitol, Sucrose and/or Trehalose in a medium for the rehydration of stem cells.

24. The method of claim 23, wherein the dried cells are exposed to irradiation such as UV.

25.-43. (canceled)

44. A device for freeze drying a biological sample, comprising:
a) a first container having a first internal space, the first container configured for storing the biological sample exposed to an internal environment of the first internal space, wherein the first container is configured to facilitate sublimation of ice crystals from the biological sample; and
b) a condenser configured to be subjected to a cool environment to facilitate phase transition of water vapors into a solid, the condenser having a second internal space in communication with the first internal space, the first and second internal spaces forming a closed chamber such that the biological sample and the condenser are in the same chamber and the chamber couplable to a vacuum pump;
c) wherein the first container and the condenser are configured to prevent exchange of particles between the closed internal space and an external environment.

45. The device of claim 44, further comprising a cooling element for supplying energy to the condenser to cool the condenser and the first and second internal space.

46. The device of claim 45, wherein the device is positionable in a container of cryogenic fluid to cool the condenser.

47. The device of claim 46, wherein the cryogenic fluid is in the container at a first level and the condenser is positionable in the container spaced from the cryogenic fluid so the condenser remains outside the cryogenic fluid.

48. The device of claim 47 in combination with the container of cryogenic fluid, wherein an elevation element is positioned in the container, the elevation element supporting the condenser in a position above the cryogenic fluid level, the elevation element being adjustable to adjust a distance of the condenser above the cryogenic fluid level.

49. The device of claim 47, wherein the first container includes a plurality of cavities to receive a plurality of biological samples.

50. The device of claim 47, wherein an internal volume of the closed chamber is equal to or below 2.0 liters.

51. The device of claim 50, wherein an internal volume of the closed chamber is equal to or below 1.0 liter.

52.-58. (canceled)
